(19) United States
(12) Patent Application Publication
(10) Pub. No.: US 2026/0289679 A1
(43) Pub. Date: Sep. 24, 2026

(54) SYSTEM

(71) Applicant: SoftBank Group Corp., Tokyo (JP)

(72) Inventor: Takayuki MIURA, Tokyo (JP)

(73) Assignee: SoftBank Group Corp., Tokyo (JP)

(21) Appl. No.: 19/558,437

(22) Filed: Mar. 5, 2026

(30) Foreign Application Priority Data
Mar. 19, 2025 (JP) 2025-044936

(51) Int. Cl. G06Q 40/06; G06Q 30/0241

(52) U.S. Cl. CPC G06Q 40/065; G06Q 30/0249

(57) ABSTRACT

A system comprising a processor, in which the processor is configured to: acquire, from a database, advertising delivery data, product information, sales performance data, and all related data; provide a user interface through which a user inputs product identification information for an advertising target, an advertising period, and an advertising budget; and generate a prompt for instructing a generative AI model to generate an optimized advertising delivery plan and input the prompt into the generative AI model.

### CROSS-REFERENCE TO RELATED APPLICATION

This application is based on and claims priority under 35 USC 119 from Japanese Patent Application No. 2025-044936 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for planning and operating online advertising campaigns generally rely on static rules, manually configured bid strategies, and heuristic optimization engines that are difficult to adapt to rapidly changing market conditions, complex user behavior, and heterogeneous product portfolios. In many cases, a human operator must interpret large volumes of historical advertising delivery data, product information, and sales performance data and manually design an advertising delivery plan, which is time-consuming, requires specialized expertise, and often fails to fully exploit the available data. Furthermore, existing optimization engines are typically tailored to specific platforms or predefined objective functions and are not well suited to flexibly generating new delivery strategies or schedules when new products are introduced, when historical patterns are sparse, or when business requirements change. As the volume and variety of advertising-related data grows, it becomes increasingly difficult for conventional rule-based or fixed-model approaches to capture complex relationships between product characteristics, user segments, delivery channels, and conversion outcomes.

In addition, while generative AI models have recently demonstrated strong capabilities in producing structured text and plans from natural language prompts, conventional advertising systems do not effectively integrate such generative AI models into the end-to-end campaign planning process. In particular, there is a lack of mechanisms for automatically converting structured advertising data and user input into appropriate prompts, providing those prompts to a generative AI model, and systematically using the generated output as an optimized advertising delivery plan, schedule, or strategy.

Accordingly, there is a need for a system that can (i) automatically obtain comprehensive advertising delivery data, product information, sales performance data, and related data from a database, (ii) provide an intuitive interface through which a user specifies the advertising target product, period, and budget, and (iii) automatically generate and supply prompts to a generative AI model in order to cause the generative AI model to produce optimized advertising delivery plans, schedules, and strategies, including those based on learning from past patterns.

### SUMMARY

In order to solve the above-described problems, according to one aspect of the present invention, there is provided a system comprising a processor, wherein the processor is configured to acquire, from a database, advertising delivery data, product information, sales performance data, and all related data, provide a user interface through which a user inputs product identification information for an advertising target, an advertising period, and an advertising budget, and generate a prompt for instructing a generative AI model to generate an optimized advertising delivery plan and input the prompt into the generative AI model. By structuring the acquisition of comprehensive historical and contextual data and combining it with user-specified campaign conditions through the user interface, the processor can automatically prepare rich, context-aware prompts that cause the generative AI model to output a concrete advertising delivery plan.

According to another aspect of the present invention, the processor is further configured, based on the product identification information for the advertising target, the advertising period, and the advertising budget input by the user, to analyze the input information for the purpose of performing optimized delivery, generate a prompt for instructing the generative AI model to generate an optimized delivery schedule, and input the prompt into the generative AI model. Through this analysis step, the processor derives constraints and objectives from the user's input, such as daily budget allocations, time windows, or priority segments, and reflects these constraints and objectives in the prompt, thereby enabling the generative AI model to produce a schedule that is tailored to the specific campaign parameters defined by the user.

According to still another aspect of the present invention, the processor is further configured, in order to perform optimized delivery based on results learned from past patterns, to train the generative AI model using past data so that the generative AI model learns from past patterns, generate, based on a result of the training, a prompt for instructing the trained generative AI model to derive an optimized advertising delivery strategy, and input the prompt into the generative AI model. By training or fine-tuning the generative AI model with past advertising delivery data, product information, and sales performance data, the system enables the generative AI model to internalize relationships between delivery parameters and conversion outcomes. The processor then leverages this trained model by supplying prompts that explicitly request an optimized strategy, such as recommended bid levels, targeting parameters, and placement selections, thereby allowing the system to produce advertising delivery strategies that are adapted to historical performance patterns while still being responsive to new campaign conditions specified by the user.

The term “processor” refers to one or more hardware processing units, such as a central processing unit (CPU), a graphics processing unit (GPU), a digital signal processor (DSP), or any combination thereof, that executes instructions to perform the functions described in the present specification and claims.

The term “database” refers to any structured data storage system, including but not limited to relational databases, NoSQL databases, data warehouses, data lakes, or distributed storage systems, that stores advertising delivery data, product information, sales performance data, and related data in a manner that enables retrieval and processing by the processor.

The term “advertising delivery data” refers to data representing the execution and performance of advertising campaigns, including but not limited to impressions, clicks, conversions, costs, bid values, targeting parameters, placement parameters, time-of-day information, and campaign identifiers.

The term “product information” refers to data describing a product or service to be advertised, including but not limited to product identification information, product name, category, attributes, pricing information, availability, and catalog relationships.

The term “sales performance data” refers to data representing sales outcomes or commercial results associated with advertising activities or products, including but not limited to orders, revenue, conversion counts, conversion values, and metrics linking advertising interactions to subsequent purchases.

The term “related data” refers to any additional data associated with advertising delivery, products, or sales performance that may be used to enhance optimization or analysis, including but not limited to user segment information, demographic information, geographic information, device information, and temporal information.

The term “user interface” refers to a graphical, textual, or voice-based interface presented on a terminal or client device through which a user can view information and input data such as product identification information, advertising period, and advertising budget, and which is generated or controlled by the processor.

The term “user” refers to a human operator, such as an advertiser, campaign manager, or system administrator, who interacts with the user interface to input campaign parameters, review generated plans, and optionally approve or modify advertising delivery settings.

The term “product identification information” refers to information that uniquely or specifically identifies a product or service to be advertised, including but not limited to a stock keeping unit (SKU), product ID, catalog ID, or any other identifier used within a product database.

The term “advertising target” refers to the product or service, specified by product identification information, for which advertising is to be delivered or optimized in accordance with the campaign parameters input by the user.

The term “advertising period” refers to a time interval during which an advertising campaign is to be executed, including at least a start date and an end date, and optionally including more detailed time constraints such as time-of-day windows or day-of-week selections.

The term “advertising budget” refers to a monetary amount designated by the user as the maximum or planned expenditure for an advertising campaign over the advertising period, and which may be used by the processor as a constraint in generating optimized advertising delivery plans, schedules, or strategies.

The term “generative AI model” refers to an artificial intelligence model capable of generating outputs, such as text, structured plans, or parameter sets, in response to input prompts, and includes, for example, large language models, transformer-based models, and other neural network-based generative models.

The term “prompt” refers to a structured or unstructured input sequence provided to a generative AI model, including natural language text and optionally embedded structured data, which instructs the generative AI model to generate a particular type of output, such as an optimized advertising delivery plan, schedule, or strategy.

The term “optimized advertising delivery plan” refers to a plan generated by or via the generative AI model that specifies how advertising is to be delivered over the advertising period, including but not limited to recommended bid values, budget allocations, targeting conditions, placements, and any other parameters selected to improve or maximize performance metrics such as conversions.

The term “optimized delivery schedule” refers to a time-based allocation of advertising delivery, generated by or via the generative AI model, that specifies when and to what extent advertising is to be delivered during the advertising period, including daily or intra-day budget allocations, pacing rules, and timing preferences intended to improve or maximize campaign performance.

The term “optimized advertising delivery strategy” refers to a set of strategic parameters and rules for advertising delivery, generated by or via the generative AI model, including but not limited to bid strategies, audience targeting strategies, channel or placement choices, and budget allocation policies, which are designed to improve or maximize desired performance metrics such as conversions or return on ad spend.

The term “past data” refers to historical data stored in the database, including at least past advertising delivery data, product information, sales performance data, and related data, which can be used to train or fine-tune the generative AI model and to derive patterns or relationships relevant to future optimization.

The term “past patterns” refers to recurring relationships or trends identified from past data, including correlations between delivery parameters and performance outcomes, which can be learned by the generative AI model and utilized by the processor to guide the generation of prompts and the interpretation of the model's outputs.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

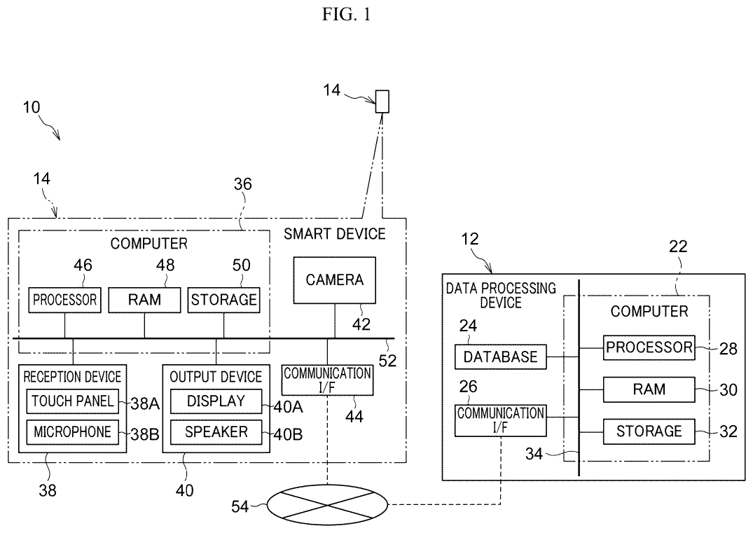

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

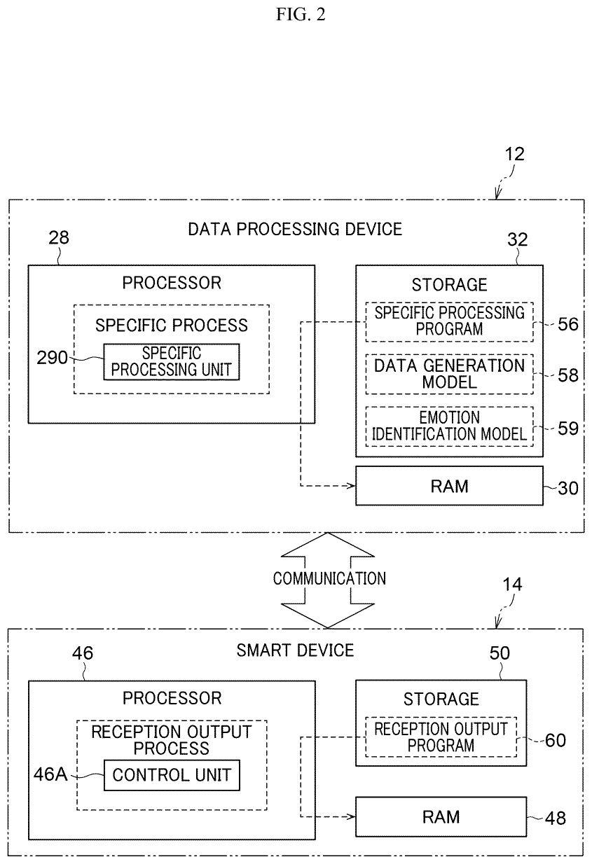

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented advertising support systems typically rely on static rule sets, manually designed heuristics, or generic machine learning models to derive advertising delivery plans from historical data. In such systems, a processor usually performs simple aggregation of impression, click, and conversion logs and then applies preconfigured business rules to allocate budgets and schedules. This architecture presents several technical problems in terms of computer technology itself.

First, these systems are not designed to dynamically transform large-scale, heterogeneous historical delivery logs, item attribute information, and transaction performance information into a machine-consumable instruction sequence for a generative AI model. Instead, they either ignore a substantial portion of the available data or pass raw or poorly summarized information to a predictive component. As a result, the computing resources of the underlying hardware, such as processors and accelerators, are not efficiently utilized, and the model's inference capability is not fully exploited, leading to suboptimal use of memory bandwidth and processing cycles.

Second, known systems generally do not perform structured, metric-driven pre-processing—such as systematic computation of click rate, conversion rate, acquisition cost, and return on investment per time slot, device type, and recipient attribute—in a way that is tightly integrated with the generation of prompt sentences for a generative AI model. Without such integration, the prompt sentences supplied to generative models tend to be loosely specified, verbose, or incomplete. This causes unstable or low-quality output from the generative model, requiring repeated calls and manual corrections, which increase CPU load, network traffic, and response latency, and which degrade the overall efficiency of the computing system.

Third, in many existing systems, the budget constraints and performance constraints specified by a user are only loosely enforced at the user interface layer or within an external advertising platform. The core planning computation performed by the server does not include robust numerical adjustment processing that guarantees consistency between the generated plan and the user's budget and target constraints. This leads to an iterative trial-and-error loop in which plans are regenerated, modified, and revalidated, causing redundant database accesses, repeated model invocations, and increased use of processing and storage resources.

Fourth, conventional systems rarely provide a systematic mechanism for using historically computed evaluation indices to generate training prompt sentences and teacher information for fine-tuning a generative AI model itself. Without this feedback mechanism, the generative AI model cannot be adapted to the specific statistical properties and domain patterns represented in the system's own history logs. This lack of domain-specific adaptation results in lower accuracy in deriving advertising strategies, forcing auxiliary rule-based corrections, additional computation, and excess memory usage, and ultimately limiting scalability and throughput of the server under high load.

Accordingly, there is a need for an improved computer-implemented system and server architecture that (i) automatically transforms historical delivery and performance data into structured evaluation indices, (ii) embeds summarized and constraint-driven information into prompt sentences supplied to a generative AI model, (iii) performs integrated numerical adjustment to enforce user-specified budget conditions at the plan generation stage, and (iv) uses evaluation indices to generate training prompt sentences and teacher information for improving the generative AI model. Such a system should reduce redundant computation, improve the stability and quality of generated advertising plans, and more efficiently use processor, memory, and network resources in the server environment.

The specific processing by the specific processing unit 290 of the data processing device 12 in Example 1 is realized by the following means.

The present invention provides a server comprising a processor and a storage device, wherein the processor is configured to retrieve, from an information collection stored in the storage device, delivery history information related to information distribution, attribute information related to a distribution target item, performance information related to a transaction result, and information related thereto; to provide, by using a display device and an input device, a user interface screen for allowing a user to input condition information including identification information of the distribution target item, a distribution period, and a distribution budget, and acquire the condition information input by the user; to perform statistical processing and numerical calculation on the retrieved delivery history information, attribute information, and performance information to generate evaluation indices including at least a click rate, a conversion rate, an acquisition cost, and a return on investment for each of a time slot, a terminal type, and a recipient attribute, and extract, based on the evaluation indices, distribution conditions and allocation policies having high effectiveness of information distribution; to generate, based on the extracted distribution conditions and allocation policies and the condition information input by the user, a prompt sentence including an instruction statement for instructing a generative artificial intelligence model to generate a distribution plan, and embed summary information of the delivery history information and the evaluation indices into the prompt sentence and transmit the prompt sentence as input to the generative artificial intelligence model; to acquire, from the generative artificial intelligence model, structured distribution plan information including at least a bidding method, a budget allocation, a distribution time slot, a recipient attribute, and a predicted number of conversions, and perform numerical adjustment processing on the distribution plan information so that the distribution plan information satisfies the distribution budget condition of the user; to convert the distribution plan information after the numerical adjustment into a format displayable on the user interface screen and output the distribution plan information to the display device, and receive an approval instruction from the user; and, in response to the approval instruction from the user, to register, through a communication interface of an external distribution infrastructure, a distribution setting based on the distribution plan information, and wherein the processor is further configured to, when the condition information including the identification information of the distribution target item, the distribution period, and the distribution budget input by the user is accepted, preferentially extract, from among the evaluation indices obtained by the statistical processing and the numerical calculation, a time slot and a recipient attribute in which the conversion rate or the return on investment is equal to or greater than a predetermined threshold in a predetermined period and describe an extraction result as an explicit constraint condition in the prompt sentence so as to instruct the generative artificial intelligence model to optimize a distribution schedule and a budget allocation, and to generate a training prompt sentence and teacher information for training or fine-tuning the generative artificial intelligence model by using the evaluation indices generated based on the delivery history information, the attribute information, and the performance information, and input the training prompt sentence to the generative artificial intelligence model to obtain a generative artificial intelligence model having improved accuracy in deriving a distribution strategy based on past distribution results and use the generative artificial intelligence model having the improved accuracy to acquire the distribution plan information. This enables the computing system to transform large-scale historical data into compact, constraint-aware prompt sentences that drive a generative artificial intelligence model, to generate distribution plans that already satisfy user budget conditions with reduced need for manual correction, and to iteratively adapt the generative artificial intelligence model to domain-specific patterns, thereby improving the efficiency, stability, and overall performance of the server in executing advertising planning computations.

The term “system” refers to a combination of hardware and software components, including at least one processor and one storage device, that cooperatively execute processing steps to perform advertising-related information distribution planning.

The term “processor” refers to an electronic computation unit, such as a central processing unit or a hardware accelerator, that executes instructions to perform data retrieval, statistical processing, prompt generation, model interaction, numerical adjustment, and output control.

The term “storage device” refers to a non-transitory computer-readable medium, such as a magnetic storage, optical storage, or semiconductor memory, that stores delivery history information, attribute information, performance information, and program instructions.

The term “information collection” refers to an organized set of data stored in the storage device, including multiple kinds of records such as logs, item attributes, and transaction results, which are used as input for analysis and plan generation.

The term “delivery history information” refers to data representing past distribution of advertising or other information, including records of impressions, clicks, display times, device types, audience segments, and related distribution parameters.

The term “attribute information” refers to data describing characteristics of a distribution target item, including identification codes, categories, descriptive features, and price-related information.

The term “performance information” refers to data representing outcomes of transactions or user actions linked to distributed information, including sales quantities, revenue amounts, conversions, and other performance metrics.

The term “distribution target item” refers to a product, service, or other entity to be promoted or exposed through an information distribution process, which is identified by identification information.

The term “identification information” refers to data that uniquely or specifically indicates a distribution target item, such as an item code, a product identifier, or a similar reference key.

The term “distribution period” refers to a time interval, including at least a start time and an end time, during which information distribution for a distribution target item is scheduled to occur.

The term “distribution budget” refers to a numerical constraint indicating an upper limit or allocated amount of resources, such as monetary cost, to be spent on information distribution within a given distribution period.

The term “condition information” refers to input data that specifies constraints and requirements for generating a distribution plan, including at least identification information of a distribution target item, a distribution period, and a distribution budget.

The term “user interface screen” refers to a visual presentation generated on a display device that allows a user to input, modify, and confirm condition information and to view a generated distribution plan.

The term “display device” refers to an output component, such as a monitor or a screen of a portable terminal, that visually presents information generated by the processor to a user.

The term “input device” refers to a user-operable component, such as a keyboard, a pointing device, a touch panel, or similar input means, that allows a user to enter condition information and operation instructions.

The term “statistical processing” refers to a set of computational operations that aggregate, summarize, and analyze numerical data using techniques such as counting, averaging, grouping, and calculating proportions or rates.

The term “numerical calculation” refers to arithmetic or algebraic operations, including division, multiplication, addition, subtraction, and other quantitative computations, performed on data values to derive evaluation indices or adjusted values.

The term “evaluation indices” refers to computed metrics that quantitatively represent the effectiveness or efficiency of information distribution, including a click rate, a conversion rate, an acquisition cost, and a return on investment.

The term “click rate” refers to a metric representing the ratio of the number of clicks to the number of impressions or exposures of distributed information, typically expressed as a percentage.

The term “conversion rate” refers to a metric representing the ratio of the number of conversions, such as purchases or desired actions, to the number of clicks or impressions, typically expressed as a percentage.

The term “acquisition cost” refers to a metric representing an average cost required to obtain a single conversion, calculated by dividing a total cost of distribution by the number of conversions.

The term “return on investment” refers to a metric representing a ratio of revenue or profit obtained from distribution to the cost of distribution, indicating an efficiency of spending.

The term “time slot” refers to a subdivision of time, such as a range of hours within a day or specific periods within a week, used for aggregating performance data and scheduling distribution.

The term “terminal type” refers to a classification of endpoint devices used by recipients to receive distributed information, such as portable terminals, stationary terminals, or other device categories.

The term “recipient attribute” refers to a characteristic of a user or audience member receiving distributed information, such as demographic category, interest category, geographic location, or usage behavior type.

The term “distribution conditions” refers to parameters that specify how information is to be distributed, including selected time slots, terminal types, and recipient attributes derived from evaluation indices.

The term “allocation policies” refers to rules or patterns for distributing resources, such as budget or impression volume, across different distribution conditions in order to improve effectiveness.

The term “prompt sentence” refers to a text sequence supplied as input to a generative artificial intelligence model, including an instruction statement, context information, and constraints that guide generation of a distribution plan.

The term “instruction statement” refers to a part of a prompt sentence that explicitly directs the generative artificial intelligence model to perform a particular task, such as generating a distribution plan or optimizing a schedule.

The term “summary information” refers to a condensed representation of delivery history information and evaluation indices, expressed in a compact textual or structured form suitable for inclusion in a prompt sentence.

The term “generative artificial intelligence model” refers to a computational model, such as a machine-learned generative model, that generates text or structured data outputs based on input prompt sentences and learned parameters.

The term “structured distribution plan information” refers to distribution plan data organized in a defined format, such as a data structure or schema, including specific fields like bidding method, budget allocation, distribution time slot, recipient attribute, and predicted number of conversions.

The term “bidding method” refers to a strategy or rule for determining bids or cost-per-event values in an information distribution platform, such as a method targeting a specific acquisition cost or an impression-based bidding scheme.

The term “budget allocation” refers to a distribution of the total distribution budget across multiple time periods, audience segments, or other distribution conditions.

The term “predicted number of conversions” refers to a forecasted quantity of conversions expected to occur under a generated distribution plan, as estimated by the generative artificial intelligence model or subsequent processing.

The term “numerical adjustment processing” refers to computations that modify values within structured distribution plan information, such as budget amounts or bid levels, to ensure compliance with user-defined constraints including a distribution budget.

The term “approval instruction” refers to an input received from a user that indicates acceptance or confirmation of a generated distribution plan and authorizes registration of corresponding distribution settings.

The term “external distribution infrastructure” refers to a separate information distribution platform or service, such as an advertising delivery platform, accessible through a communication interface for registering and executing distribution settings.

The term “communication interface” refers to a hardware and software mechanism, such as a network interface and protocol stack, that enables data exchange between the server and an external distribution infrastructure.

The term “constraint condition” refers to a requirement or limit, such as a threshold on conversion rate or return on investment, that is explicitly described in a prompt sentence to constrain behavior of the generative artificial intelligence model.

The term “predetermined threshold” refers to a reference value, set in advance by configuration or logic, against which evaluation indices such as conversion rate or return on investment are compared.

The term “training prompt sentence” refers to a prompt sentence constructed for the purpose of training or fine-tuning a generative artificial intelligence model, typically combined with teacher information to adjust model parameters.

The term “teacher information” refers to target outputs or labels associated with a training prompt sentence, used as supervision for training or fine-tuning a generative artificial intelligence model.

The term “fine-tuning” refers to a process of updating parameters of an already-trained generative artificial intelligence model using additional domain-specific data, so as to improve accuracy for particular tasks or data distributions.

The term “distribution strategy” refers to an overall plan or policy specifying how, when, where, and to whom information is to be distributed, including selection of bidding methods, allocation policies, and target segments.

The term “past distribution results” refers to historical outcomes of information distribution, including realized impressions, clicks, conversions, costs, and performance metrics obtained from prior campaigns or distribution activities.

In one embodiment, a server, a terminal, and a user cooperate to implement the invention. The server includes at least one processor, a main memory, a non-transitory storage device, and a network interface. The terminal includes a display device and an input device, such as a touch panel. The user operates the terminal to provide condition information and to approve or reject an automatically generated distribution plan.

The server uses a general-purpose computing platform, for example a server-class computer with a central processing unit such as an x86-compatible processor, a main memory such as dynamic random access memory, a storage device such as a solid-state drive, and a network interface card for packet-based communication. In some embodiments, the server additionally uses a hardware accelerator such as a graphics processing unit to execute neural network operations associated with a generative AI model. The server executes system software, such as a general-purpose operating system, and application software, such as a web server, an application server, and data processing libraries. For instance, the server uses a web server program, an application framework implemented in a programming language, and a data analysis library such as a tabular-processing library and a numerical computation library. The server uses a database management system, such as a relational database engine, to store and retrieve delivery history information, attribute information of target items, and performance information associated with transactions.

The terminal uses a web browser or a native application to render a user interface screen generated by the server. The terminal receives from the user identification information of a distribution target item, a distribution period, and a distribution budget. The terminal converts the user inputs into structured condition information and transmits the condition information to the server via a network protocol such as Hypertext Transfer Protocol Secure over an internet protocol network. The terminal subsequently receives a distribution plan from the server and renders the plan in a human-readable format. The user observes the displayed plan and, using the input device, issues an approval instruction or modification commands. The terminal transmits the approval instruction or modified condition information back to the server.

The server stores, in the storage device, data structures representing multiple kinds of information. In one example, the server stores delivery history information in a table-like structure having fields such as campaign identifier, target item identifier, date, time slot, device type, recipient attribute, number of impressions, number of clicks, number of conversions, and total cost. The server stores attribute information of target items in a separate table-like structure having fields such as item identifier, category code, price range, and descriptive attributes. The server stores performance information in another table-like structure having fields such as transaction date, target item identifier, sales quantity, and revenue amount. Each table-like structure is indexed by one or more fields, such as an item identifier and a date, so that the server can retrieve related records with reduced disk access and improved query performance.

The server uses the processor to load relevant portions of the delivery history information, attribute information, and performance information from the storage device into the main memory. The server uses a data analysis library to join, group, and aggregate these records. The server computes evaluation indices, including click rate, conversion rate, acquisition cost, and return on investment, for each combination of time slot, terminal type, and recipient attribute. For example, the server calculates a click rate by dividing a count of clicks by a count of impressions, calculates a conversion rate by dividing a count of conversions by a count of clicks, calculates an acquisition cost by dividing a total cost by a count of conversions, and calculates a return on investment by dividing a revenue amount by a total cost. The server stores these evaluation indices in in-memory data structures, such as arrays and hash maps keyed by time slot, terminal type, and recipient attribute. This structured metric computation and indexing enables the processor to access relevant performance information with reduced time complexity and fewer cache misses, thereby improving processing speed compared to ad-hoc or manual analysis.

The server analyzes the computed evaluation indices to extract distribution conditions and allocation policies that have high effectiveness. In some embodiments, the server compares each evaluation index against a predetermined threshold. For example, the server identifies a time slot and a recipient attribute for which a conversion rate or a return on investment exceeds the threshold within a specified historical period. The server represents these preferred conditions as constraint records, which the processor stores in a constraint data structure. By performing this comparison and constraint extraction in the main memory using vectorized operations provided by the numerical computation library, the server reduces computational overhead and achieves faster selection of high-performing conditions than a simplistic row-by-row scanning approach.

The server then generates a prompt sentence for a generative AI model. The server forms the prompt sentence as a text string that includes an instruction statement, context information, and one or more constraint conditions. The server embeds summary information representing delivery history information and evaluation indices into the prompt sentence. For example, the server composes a prompt sentence as follows:
“You are an advertising distribution optimization engine.”

Analyze the following historical distribution data for the target item identified as ITEM-XYZ and generate an optimal one-week distribution plan under a total budget of 1,000,000 units of currency.

### Historical Summary:

The highest conversion rates occurred on weekdays between 18:00 and 22:00 on portable terminals.
The highest return on investment was obtained when targeting recipients aged 25 to 34 with sports-related interests.
The average acquisition cost during the last 30 days was 3,500 units of currency.

### Requirements:

1. Select an appropriate bidding method and specify its parameters.
2. Allocate the total budget across days of the week and time slots to maximize the expected number of conversions.
3. Propose recipient attribute conditions and terminal types for distribution.
4. Provide estimated impressions, clicks, and conversions.

### Constraints:

Prioritize weekdays between 18:00 and 22:00.
Ensure that the total cost does not exceed 1,000,000 units of currency.

“Output the result in a structured format with clear sections for bidding method, budget allocation, schedule, target recipients, and estimated results.”

The server constructs such a prompt sentence using programmatic string concatenation and template substitution. The server inserts specific time slots, recipient attributes, and numerical values derived from the evaluation indices and from the condition information input by the user. Unlike a manual or ad-hoc description, this automatic prompt construction ensures that statistically significant patterns are encoded as explicit constraints, thereby guiding the generative AI model toward solutions that reflect actual historical performance and user-specified budget limits.

The server uses a generative AI model implemented as a neural network, for example a transformer-based language model having multiple attention layers, feedforward layers, and normalization layers. The neural network is parameterized by weight matrices and bias vectors that are stored in a model file on the storage device and loaded into memory or accelerator memory when executed. The server represents input tokens as numerical vectors using an embedding layer, processes the token sequence through stacked self-attention blocks, and decodes output tokens through a softmax layer. The server uses a training procedure in which the neural network parameters are updated based on a loss function such as cross-entropy between predicted token distributions and target token sequences. The server uses gradient-based optimization, such as stochastic gradient descent with momentum or an adaptive method, to update model parameters. In some embodiments, the server performs fine-tuning of the generative AI model using domain-specific prompt sentences and teacher information generated from historical distribution results.

The server generates training prompt sentences and associated teacher information by using evaluation indices and observed outcomes stored in the storage device. For example, the server constructs a training prompt sentence such as:
“Given the following historical distribution conditions and results, generate a distribution strategy that would have increased the number of conversions by at least 10 percent without exceeding the original budget.”

### Conditions:

### Target Item: Item-ABC

Weekdays, 12:00-16:00, stationary terminals, recipients aged 35-44

### Results:

Impressions: 100,000
Clicks: 3,000
Conversions: 150
Cost: 600,000 units of currency
Acquisition cost: 4,000 units of currency
Return on investment: 2.0

Output: “A detailed strategy specifying adjusted time slots, recipient attributes, and bidding method.”

The server uses the actual improved strategy or an analytically derived optimal strategy as teacher information. The server then performs fine-tuning by feeding such training prompt sentences and teacher information into the neural network and updating its parameters using the loss function that measures the difference between predicted and target strategies. This process causes the model to learn domain-specific relationships between evaluation indices, constraints, and effective strategies, thereby improving the accuracy and stability of generated distribution plans.

The server interacts with the generative AI model either by calling a local inference engine running on an attached hardware accelerator or by sending the prompt sentence to a remote model execution environment over the network. In the case of local execution, the server transfers the embedded prompt tokens to the accelerator memory and triggers kernel operations that perform matrix multiplications, attention score computations, and non-linear activation functions. By batching multiple prompts or using efficient attention implementations, the server reduces the number of memory accesses and computations per token, which results in improved throughput and reduced latency. In the case of remote execution, the server compresses prompt sentences where appropriate and uses persistent connections or multiplexed request handling to reduce communication overhead.

The server receives from the generative AI model structured distribution plan information. The generated plan includes, for example, a bidding method, a distribution of budget across days and time slots, preferred recipient attributes, and predicted numbers of impressions, clicks, and conversions. The plan is typically represented in a machine-readable format, which the server parses into internal data structures, such as nested dictionaries or structured records. The server then performs numerical adjustment processing to ensure that the sum of allocated budgets does not exceed the distribution budget specified by the user, and that other constraints, such as maximum daily spending, are not violated. The server uses arithmetic operations to scale or reallocate budget amounts, and, if necessary, to adjust bid levels while preserving relative allocation ratios recommended by the generative AI model. This automatic numerical reconciliation, performed prior to registration with an external distribution infrastructure, reduces or eliminates the need for human correction and prevents invalid or inconsistent settings from being transmitted.

The server then converts the adjusted distribution plan information into a display format suitable for the terminal. The server generates text summaries and tabular data describing the recommended bidding method, daily and hourly budget allocations, target recipient attributes, and predicted performance metrics. The server transmits these display data to the terminal. The terminal renders the information using user interface components such as tables, charts, and text labels. The user can verify details and, if desired, modify some parameters. Because the server has already enforced budget constraints and integrated historical performance constraints into the plan, the number of cycles of modification and regeneration is significantly reduced, thereby decreasing total computational load and network traffic.

When the user issues an approval instruction, the server uses a communication interface to register the distribution settings with an external distribution infrastructure. The server translates the internal distribution plan into one or more configuration requests compliant with the application programming interface of the external infrastructure. The server then transmits these configuration requests over a network protocol. The external infrastructure stores the configuration and begins executing actual information distribution, such as advertisement delivery, in accordance with the registered plan. In this manner, the server does not merely simulate or display a hypothetical plan; the server directly controls the configuration of external hardware and software resources that implement real-world distribution of information, thereby tying the computational process to a concrete technical effect in the physical networked environment.

Because the server computes evaluation indices in an integrated manner and encodes them into constraint-aware prompt sentences, the generative AI model is not used as a generic text generator but rather as a component in a structured optimization pipeline. The server's pre-processing and constraint embedding reduce the search space that the model must explore, improving convergence of generated solutions and reducing the number of model invocations needed to obtain a viable plan. Furthermore, by fine-tuning the model using domain-specific training prompt sentences and teacher information, the server improves the alignment between model outputs and the performance characteristics of the particular dataset. This reduces prediction error, decreases variance in plan quality, and contributes to more stable utilization of processing resources, because fewer corrective iterations are required. The described architecture improves computer technology in several ways. First, structured computation of evaluation indices and constraint extraction, implemented with vectorized numerical libraries and indexed database access, leads to faster analytics and reduced memory bandwidth usage compared to unstructured manual queries. Second, the generation of compact, constraint-rich prompt sentences minimizes token length while maximizing information density, thereby reducing both processing time within the generative AI model and network bandwidth when prompts are transmitted to a remote model server. Third, the automatic numerical adjustment of generated plans prior to external registration reduces the number of invalid or rejected configurations, decreasing unnecessary back-and-forth communication with external infrastructures. Fourth, iterative fine-tuning of the generative AI model using internally generated training data reduces dependence on external training data, and results in models that produce accurate plans in fewer inference steps, further improving computational efficiency.

In another embodiment, the server uses alternative model architectures. For example, the server uses a sequence-to-sequence neural network with an encoder that consumes a compact representation of evaluation indices and a decoder that emits a structured plan description. In this case, the server constructs a feature vector for each candidate time slot and recipient attribute, including fields such as normalized click rate, normalized conversion rate, logarithm of acquisition cost, and standardized return on investment. The server arranges these vectors into a sequence and encodes them through recurrent or attention-based layers. The decoder then generates plan tokens that describe which combinations of time slots and recipient attributes should be included in the final distribution plan. The server trains this model using a loss function that penalizes deviations from known good strategies and violations of budget constraints, thereby embedding optimization behavior directly into the neural network weights.

In yet another embodiment, the server employs a hybrid rule-based and generative approach. The server first filters out time slots and recipient attributes that consistently perform below a minimal threshold, using deterministic rules implemented in the processor. The server then passes only the remaining high-potential segments to the generative AI model via the prompt sentence. This decoupled pre-filtering reduces the dimensionality of the planning problem and focuses the model's computational resources on promising segments, thereby reducing inference time and improving overall throughput. This non-conventional combination of deterministic pre-filtering with generative reasoning differs from simple automation of human planning and provides an algorithmic structure that is specifically adapted to computer execution.

The foregoing description illustrates that the server, terminal, and user cooperate to implement the invention using specific data structures, numerical computations, neural network architectures, and communication protocols. The defined flow of metrics computation, prompt sentence generation, generative AI inference, numerical adjustment, and external configuration results in tangible improvements in processing speed, plan accuracy, and resource utilization, and provides a technical solution that goes beyond mere automation of human judgment.

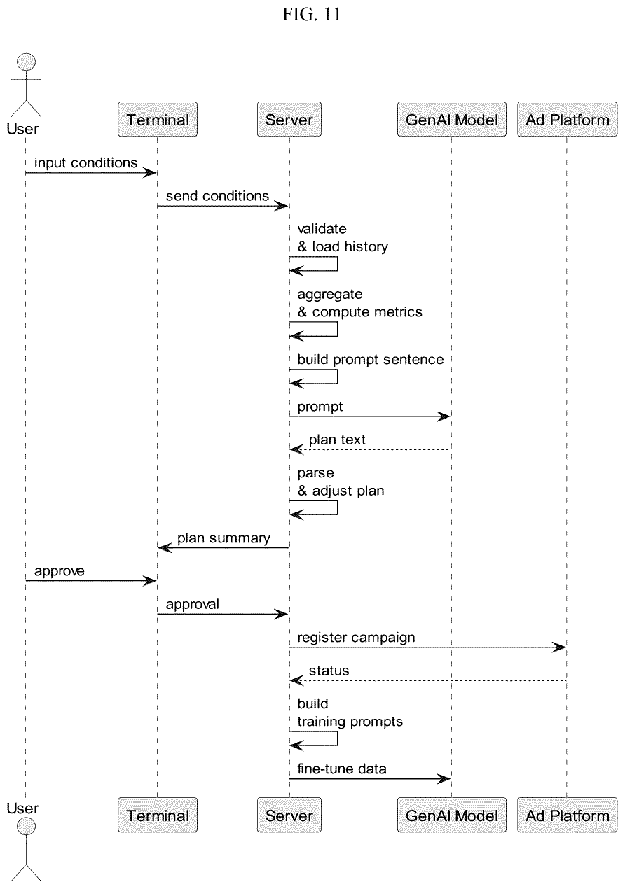

The following describes the processing flow using FIG. 11.
Step 1:

The user operates the terminal to input condition information.

The user uses the display device and input device of the terminal to open a campaign setting screen and to enter identification information of a distribution target item, a distribution period, and a distribution budget. The terminal receives, as input, raw keystrokes or touch events representing item identifiers, dates, and numeric budget values. The terminal performs local validation, such as checking that the dates form a valid period and that the budget is a positive number, and converts the validated inputs into structured condition information. The terminal then outputs this condition information in a structured representation to the server via a network request.
Step 2:

The server receives and validates the condition information.

The server receives, as input, the structured condition information transmitted from the terminal. The server parses the received data and checks the presence and format of identification information, the distribution period, and the distribution budget. The server performs data validation processing, including verifying that the distribution period has a start date earlier than an end date and that the distribution budget does not exceed a predefined maximum limit. Based on this validation, the server outputs a normalized internal condition object that will be used as a basis for subsequent data retrieval and analysis operations.
Step 3:

The server retrieves historical data from storage.

The server uses the internal condition object as input to form database queries. The server sends these queries to a storage device managed by a database management system to retrieve delivery history information, attribute information, and performance information associated with the specified distribution target item and one or more historical periods. The server receives, as output from the storage device, sets of records for delivery logs, item attributes, and transaction results. The server then stores these records in main memory as table-like data structures for further processing.
Step 4:

The server preprocesses and aggregates the historical data.

The server takes the raw historical records loaded into memory as input and applies data processing operations including joining, filtering, and grouping. The server joins delivery history information with attribute information and performance information based on common identifiers such as item identifiers and dates. The server filters the joined data by relevant time windows and removes incomplete or inconsistent records. The server then groups the filtered records by time slot, terminal type, and recipient attribute and computes, for each group, aggregated counts of impressions, clicks, conversions, and total cost. The server outputs aggregated datasets in which each record represents a unique combination of time slot, terminal type, and recipient attribute with corresponding aggregate metrics.
Step 5:

The server computes evaluation indices from aggregated data.

The server receives the aggregated datasets as input and performs numerical calculations to derive evaluation indices. For each group defined by time slot, terminal type, and recipient attribute, the server computes a click rate by dividing a count of clicks by a count of impressions, computes a conversion rate by dividing a count of conversions by a count of clicks, computes an acquisition cost by dividing total cost by the number of conversions, and computes a return on investment by dividing revenue by total cost. The server handles edge cases, such as zero impressions or zero conversions, by applying predefined safeguards to avoid division by zero. The server then outputs a metrics table in which each row contains the grouping keys and the calculated evaluation indices.
Step 6:

The server extracts high-effectiveness distribution conditions.

The server uses the metrics table as input and compares each evaluation index against one or more predetermined thresholds, such as a minimum conversion rate or minimum return on investment. The server identifies combinations of time slot, terminal type, and recipient attribute that satisfy these thresholds. The server then selects these combinations as preferred distribution conditions. The server outputs a set of constraint records representing these preferred conditions, including associated metric values, for use in later prompt sentence generation.
Step 7:

The server generates a constraint-aware prompt sentence.

The server takes as input the condition object from Step 2, the metrics table from Step 5, and the constraint records from Step 6. The server generates text segments summarizing historical performance, such as the best-performing time slots and recipient attributes. The server then concatenates an instruction statement, the historical summary, the user's requested budget and period, and explicit constraints derived from the constraint records into a single prompt sentence for the generative AI model. For example, the server outputs a prompt sentence such as:
“You are an advertising distribution optimization engine.”

Analyze the following historical distribution data for the specified target item and generate an optimal one-week distribution plan under the given total budget.

### Historical Summary:

The highest conversion rates occurred on weekdays between 18:00 and 22:00 on portable terminals.
The highest return on investment was obtained when targeting recipients aged 25 to 34 with sports-related interests.
The average acquisition cost during the last 30 days was 3,500 units of currency.

### Requirements:

1. Select an appropriate bidding method and specify its parameters.
2. Allocate the total budget across days of the week and time slots to maximize the expected number of conversions.
3. Propose recipient attribute conditions and terminal types for distribution.
4. Provide estimated impressions, clicks, and conversions.

### Constraints:

Prioritize weekdays between 18:00 and 22:00.
Ensure that the total cost does not exceed the specified budget.

“Output the result in a structured format with clear sections for bidding method, budget allocation, schedule, target recipients, and estimated results.”

The server outputs this prompt sentence as a text string to be used as input to the generative AI model.
Step 8:

The server interacts with the generative AI model to obtain a distribution plan.

The server uses the prompt sentence from Step 7 as input to a generative AI model implemented as a neural network. The server converts the prompt sentence into token identifiers using a tokenizer and then into numerical vectors via an embedding layer. The server either invokes a local inference engine or sends the embedded prompt over a network to a remote model execution environment. The generative AI model processes the embedded sequence through its layers, performing matrix multiplications, attention operations, and non-linear transformations to generate output token probabilities. The server decodes these probabilities into an output text that describes a structured distribution plan including recommendations for bidding method, budget allocations by day and time, target recipient attributes, and predicted performance metrics. The server parses the generated text into an internal structured distribution plan object, which is the output of this step.
Step 9:

The server performs numerical adjustment of the distribution plan.

The server receives the structured distribution plan object as input and verifies that the total of proposed budget allocations does not exceed the distribution budget specified in the condition information. The server calculates the sum of all per-period budget allocations and compares this sum to the user's budget. If the sum exceeds the budget, the server computes a scaling factor as the ratio of the user's budget to the sum of allocations. The server then multiplies each allocation by this scaling factor, using floating-point arithmetic, and, if necessary, rounds to appropriate currency units. The server updates the distribution plan object with these adjusted values. The server outputs an adjusted distribution plan that satisfies the budget constraint while preserving the relative allocation ratios determined by the generative AI model.
Step 10:

The server formats and transmits the adjusted plan to the terminal.

The server takes the adjusted distribution plan object as input and converts it into display-friendly data, including human-readable descriptions and tabular representations of daily budgets, time-slot distributions, and target recipient attributes, along with predicted impressions, clicks, and conversions. The server organizes these data into a response structure and sends the structure to the terminal via a network response. The server outputs this response as the final result of the plan-generation phase.
Step 11:

The terminal displays the distribution plan and accepts user actions.

The terminal receives, as input, the response containing the adjusted distribution plan from the server. The terminal parses the response and renders a graphical layout in which the user can view the proposed bidding method, budget allocations, schedule, and target audiences. The terminal displays summary text and detailed tables, and may display charts that visualize budget distribution across days and time slots. The terminal then waits for user actions, such as an approval instruction or modification commands. When the user interacts with the user interface, the terminal gathers the corresponding input events and outputs either an approval instruction or updated condition information to the server.
Step 12:

The server processes the approval instruction and registers settings with an external infrastructure.

The server receives, as input, an approval instruction associated with the adjusted distribution plan from the terminal. The server maps the internal fields of the distribution plan object to the configuration parameters required by an external distribution infrastructure. The server then constructs configuration messages specifying campaign parameters, budget limits, schedules, and targeting rules. The server sends these messages through a communication interface using the protocol defined by the external infrastructure. The external infrastructure returns responses indicating success or failure of registration. The server records these responses and outputs a registration status, which can be reported back to the terminal if needed.
Step 13:

The server generates training prompt sentences and teacher information for fine-tuning.

The server uses historical delivery history information, attribute information, performance information, and resulting evaluation indices as input for training data generation. The server selects representative historical campaigns and computes, for each, evaluation indices and known effective strategies or empirically improved strategies. The server then composes training prompt sentences describing initial conditions and outcomes, and associates each with teacher information that describes a preferred or improved strategy. The server outputs these training prompt sentences and teacher information as a dataset suitable for training or fine-tuning the generative AI model.
Step 14:

The server fine-tunes the generative AI model using generated training data.

The server receives the training prompt sentences and teacher information as input and passes them through the generative AI model in a training mode. For each training prompt sentence, the server tokenizes the text, computes embeddings, and performs forward passes through the neural network to obtain predicted token sequences. The server computes a loss value, such as cross-entropy, between the predicted sequences and the teacher information sequences. The server then computes gradients of the loss with respect to model parameters and updates the parameters using an optimization algorithm such as stochastic gradient descent or an adaptive optimizer. The server repeats these operations over multiple training iterations, thereby adjusting the model weights to better reflect domain-specific patterns. The server outputs an updated generative AI model with improved accuracy in deriving distribution strategies based on past distribution results.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented advertising management systems typically rely on static rules, manually configured bidding strategies, or simple heuristics that are hard-coded into application logic. In such systems, a server often retrieves historical campaign data and stores it in a database, but uses the data only for coarse reporting or dashboard display. As a result, the server fails to fully exploit complex patterns across large-scale historical records, such as interactions between bid levels, audience attributes, distribution time periods, and budget allocation patterns. This leads to suboptimal utilization of computing resources and network resources, because repeated manual tuning by human operators generates redundant data transfers and model retraining, and because campaign configuration updates are frequently performed in an ad hoc manner.

In addition, in conventional systems that introduce machine learning, a prediction model is usually trained in isolation and used only to output a small number of aggregate performance indicators. The server does not systematically generate and evaluate a structured space of candidate distribution conditions, nor does it apply constraint-aware optimization at the machine-level to automatically identify an optimal set of conditions. The system therefore leaves much of the decision-making to human operators, who must interpret raw metrics and manually adjust bids and targeting. This increases latency in campaign optimization, creates inconsistent quality of results, and causes excessive load on storage and communication interfaces due to repeated trial-and-error updates.

Furthermore, conventional systems that use a generative AI model often apply such a model in a loosely coupled, ad hoc way: a user manually prepares a free-form textual description and submits it to an external generative service. The server treats the response merely as unstructured advice and does not integrate the generative AI model into a closed-loop control mechanism. In particular, the server does not generate standardized prompt sentences from structured historical information and does not parse the returned natural language into machine-actionable improvement plans that can be directly translated into updates to distribution setting information. This lack of integration prevents the generative AI model from being used as an effective part of the core optimization pipeline and leads to inefficiencies and inconsistencies in the system's computational behavior.

Moreover, known systems rarely implement continuous online improvement in which a server periodically acquires distribution result indicators from an external distribution management service, updates a prediction model with newly acquired historical information, and coordinates the updated model with a generative AI model. Without this continuous cycle, the server cannot adapt the underlying prediction logic and prompt generation to recent traffic conditions, market variations, or constraint changes, resulting in performance degradation over time and inefficient use of processing resources.

Accordingly, there is a need for a computer-implemented technique that improves the functioning of an advertising optimization server itself. Such a technique should enable the server to: (i) automatically preprocess large-scale historical information as tabular data, (ii) construct and use a prediction model to evaluate a structured space of candidate distribution conditions under explicit constraints, (iii) generate standardized prompt sentences embedding summary information, (iv) interact with a generative information processing model to obtain natural-language proposal content, (v) convert selected improvement plans into structured update requests toward an external distribution management service, and (vi) perform continuous relearning and closed-loop optimization. By solving these issues at the system level, the invention aims to reduce manual intervention, reduce redundant data processing and communication, and improve the technical efficiency and stability of computer-based advertising distribution control.

The specific processing by the specific processing unit 290 of the data processing device 12 in Application Example 1 is realized by the following means.

The present invention provides a server comprising a processor configured to acquire, from an information storage device, historical information including distribution history information, attribute history information, and transaction history information, to load the historical information as tabular data and perform preprocessing including missing-value completion, value conversion, attribute integration, and indicator calculation so as to generate features suitable for machine learning, to construct a prediction model using a machine learning algorithm based on the features and a performance indicator included in the historical information, to input a plurality of candidate distribution conditions including bid levels, target attributes, distribution time periods, and budget allocation patterns into the prediction model and identify optimal distribution conditions that maximize the performance indicator while satisfying budget and constraint conditions, to provide an operation screen via an information display device such that a user can input target identification information, a distribution period, an allocation budget, and distribution conditions, view the optimal distribution conditions, and specify modifications thereof, to communicate with an external distribution management service so as to automatically register or update distribution setting information including a distribution target, a bidding strategy, a distribution schedule, and a budget allocation based on the optimal distribution conditions and the modifications, to generate summary information including at least a campaign objective, a period, a budget, a target attribute, a distribution result indicator, and a constraint condition, to generate a prompt sentence including the summary information and input the prompt sentence into a generative information processing model, to analyze natural-language proposal content obtained from the generative information processing model so as to extract improvement plans including at least bid adjustment, target change, time period allocation change, and budget reallocation, and to convert user-selected improvement plans into update requests to the external distribution management service, change the distribution setting information based on the update requests, and accumulate post-change distribution result indicators as updated historical information in the information storage device. This enables the computer system to perform closed-loop, constraint-aware optimization of advertising distribution by tightly integrating deterministic prediction modeling and generative AI-based proposal generation, thereby reducing manual configuration effort, decreasing redundant data transfers and trial-and-error updates, and improving the overall computational efficiency and adaptability of the advertising optimization server.

The term “information storage device” refers to one or more hardware-based or virtual storage resources, such as a database system, file system, or storage array, that persistently store records including historical information used by the server.

The term “historical information” refers to accumulated data records representing past system states or events, including but not limited to past advertising distributions, past target attributes, and past transaction results, which are used as input for preprocessing and model training.

The term “distribution history information” refers to a subset of the historical information that records past advertising distribution events, including information such as when, where, and to whom advertisements were delivered, and under what configuration conditions.

The term “attribute history information” refers to a subset of the historical information that records attributes associated with advertising targets or items, such as product categories, audience segments, regions, device types, and other descriptive properties.

The term “transaction history information” refers to a subset of the historical information that records transaction-related outcomes, including events such as clicks, conversions, purchases, revenue, and other indicators of user responses to advertisements.

The term “tabular data” refers to data structured in a table-like form, such as rows and columns, where each row corresponds to a record and each column corresponds to an attribute or feature, and which can be processed by data analysis and machine learning tools.

The term “preprocessing” refers to a series of data manipulation operations applied to raw historical information, including but not limited to handling missing values, converting data types or scales, merging or aggregating attributes, and computing derived indicators, in order to make the data suitable for learning and inference.

The term “missing-value completion” refers to a preprocessing operation in which absent or undefined attribute values in the historical information are imputed, filled, or otherwise replaced according to predefined rules or statistical methods.

The term “value conversion” refers to a preprocessing operation that transforms one representation of a data value into another, such as converting categorical variables into numerical encodings, normalizing numerical ranges, or transforming timestamps into standardized formats.

The term “attribute integration” refers to a preprocessing operation that combines multiple attributes or data sources into unified attributes, such as joining records from different tables or aggregating multiple variables into composite indicators.

The term “indicator calculation” refers to a preprocessing operation that computes additional measures or metrics, such as click-through rate, conversion rate, cost per acquisition, or return on ad spend, from existing historical information.

The term “feature” refers to an individual measurable property or characteristic derived from the historical information, which is used as an input variable to a prediction model in machine learning.

The term “machine learning algorithm” refers to a computational method that infers a mapping or statistical relationship between input features and target outputs from data, and that is implemented in software executed by the processor.

The term “prediction model” refers to a data-driven model generated by applying a machine learning algorithm to features and target indicators, which model is capable of estimating one or more performance indicators for new candidate distribution conditions.

The term “performance indicator” refers to a quantitative measure used to evaluate or optimize advertising distribution, including but not limited to conversions, conversion rate, revenue, cost, or other campaign outcome metrics.

The term “candidate distribution conditions” refers to a plurality of possible configuration sets for advertising distribution, each set including parameters such as bid levels, target attributes, distribution time periods, and budget allocation patterns.

The term “bid level” refers to a numerical or categorical parameter indicating a price or cost threshold associated with acquiring advertising opportunities, such as a cost-per-click value or an equivalent bidding parameter.

The term “target attribute” refers to a property or characteristic defining a group of recipients or contexts for advertising distribution, such as demographic profile, geographic area, device type, interest category, or other segmentation criteria.

The term “distribution time period” refers to a temporal interval or schedule segment, such as a particular hour of day, day of week, or date range, during which advertising distribution is configured to occur.

The term “budget allocation pattern” refers to a rule or structure that distributes an available advertising budget across multiple units, such as time periods, audience segments, or campaigns, according to specified proportions or constraints.

The term “budget condition” refers to a constraint or limitation associated with the total amount of resources available for advertising, such as a total campaign budget, a daily budget cap, or other monetary limits.

The term “constraint condition” refers to one or more non-budget constraints imposed on advertising distribution, such as restrictions on target regions, maximum bid levels, or permissible time periods.

The term “optimal distribution conditions” refers to one or more selected distribution conditions among the candidate distribution conditions that are determined, by the prediction model and constraint logic, to maximize or otherwise optimize a performance indicator while satisfying budget and constraint conditions.

The term “information display device” refers to an electronic device capable of outputting graphical or textual information to a user, such as a mobile terminal, a tablet, a personal computer, or another display-capable apparatus.

The term “display control unit” refers to a hardware or software component that controls the rendering, layout, and updating of graphical or textual user interface elements on the information display device.

The term “operation screen” refers to a graphical user interface view presented on the information display device that enables a user to enter data, review system outputs, and specify commands or modifications through interactive elements.

The term “target identification information” refers to data that uniquely or logically specifies an advertising target, such as one or more identifiers, names, categories, or other references associated with an advertised item or audience.

The term “distribution period” refers to a time interval, defined by a start time and an end time or by recurring schedules, during which advertising distribution is planned or executed.

The term “allocation budget” refers to a quantity of resources, typically monetary, reserved for use in a particular advertising distribution context, such as a campaign-level or period-level budget.

The term “external distribution management service” refers to an external system, platform, or service that manages and executes advertising distribution operations, including handling bids, displaying ads, and recording performance metrics.

The term “distribution setting information” refers to configuration data used by the external distribution management service to control advertising distribution, including but not limited to distribution targets, bidding strategies, distribution schedules, and budget allocations.

The term “bidding strategy” refers to a configuration that determines how bid levels are set or adjusted in the external distribution management service in order to achieve particular performance goals, such as cost targets or conversion objectives.

The term “distribution schedule” refers to a configuration element that defines when advertisements will be distributed, including specific times, days, or patterns across the distribution period.

The term “campaign objective” refers to a goal or intended outcome of an advertising campaign, such as increasing conversions, maximizing revenue, or achieving a specified return on investment.

The term “distribution result indicator” refers to a measured value or metric that reports the outcome of executed advertising distribution, such as actual impressions, clicks, conversions, costs, or revenue.

The term “summary information” refers to information that condenses or aggregates detailed historical information and optimal distribution conditions into a more compact, human-readable representation, including key objectives, metrics, and constraints.

The term “prompt sentence” refers to a machine-generated textual input string provided to a generative information processing model, the string including at least summary information and instructions that specify a desired form or content of the model's output.

The term “generative information processing model” refers to a computational model, such as a generative AI model, that receives textual or structured input including a prompt sentence and produces natural-language or structured output by generating new content based on learned patterns.

The term “proposal content” refers to natural-language text or structured information output by the generative information processing model, the content including suggestions, recommendations, or analyses related to advertising distribution optimization.

The term “improvement plan” refers to a structured representation of one or more actionable modifications to advertising distribution settings, extracted from the proposal content, such as specific bid adjustments, changes in target attributes, modifications to time period allocation, or reallocations of budgets.

The term “bid adjustment” refers to a modification, expressed as an absolute or relative change, to a bid level used for advertising distribution.

The term “target change” refers to a modification to one or more target attributes, such as adding, removing, or refining audience segments or regions used for advertising distribution.

The term “time period allocation change” refers to a modification in how budget or advertising exposure is distributed across different distribution time periods.

The term “budget reallocation” refers to a modification in how an overall budget is apportioned among different components, such as campaigns, audience segments, or time periods.

The term “update request” refers to a machine-readable message or command sequence generated by the server that instructs the external distribution management service to modify specific elements of distribution setting information in accordance with an improvement plan.

The term “post-change distribution result indicator” refers to a distribution result indicator that is measured after applying one or more updates to the distribution setting information, and that reflects the outcome under the modified conditions.

The term “relearning” refers to a process in which a prediction model is retrained or incrementally updated by using historical information that includes newly added distribution result indicators, thereby adapting the model to recent data.

In one embodiment, a server cooperates with a terminal and a user to implement the claimed system. The server includes at least one processor, a main memory, and a network interface operating under control of an operating system such as a general-purpose server operating system. The server is connected to an information storage device, such as a relational database system implemented using a database engine, and to an external distribution management service via a communication network. The terminal is implemented as a mobile information processing device, such as a smartphone or tablet, including a touch-sensitive display, a local processor, and a communication interface. The user operates the terminal to supply campaign requirements and to review and select optimization results. The server stores executable software modules in the information storage device or in a non-transitory memory. The software modules include at least: a data acquisition and preprocessing module implemented in a high-level programming language such as Python, using data analysis libraries such as a tabular data processing library; a machine learning module implemented using a machine learning framework such as a general-purpose machine learning library; a generative AI interface module configured to send and receive text data to and from a generative AI model; and a distribution management interface module configured to call an external advertising distribution management service via an application programming interface.

The server acquires historical information from the information storage device in the form of relational tables. The historical information includes distribution history information, attribute history information, and transaction history information. Each of these information types is stored in specific database tables. For example, the server stores distribution history information in a table with columns such as campaign identifier, ad group identifier, audience segment identifier, date and time, bid level, distribution time period, and delivered impression count. The server stores attribute history information in a table with columns such as product identifier, product category code, audience demographic attributes, region code, device category, and other descriptive attributes. The server stores transaction history information in a table with columns such as click count, conversion count, revenue amount, cost amount, and additional performance metrics.

The server uses the data acquisition and preprocessing module to load these tables into main memory as tabular data structures, such as data frames. The server performs missing-value completion by detecting null entries and applying predetermined rules, for example replacing missing bid levels with median values per campaign, or removing rows with missing mandatory identifiers. The server performs value conversion by encoding categorical attributes using techniques such as one-hot encoding or ordinal encoding and by normalizing numerical values such as costs and revenues into standardized ranges. The server performs attribute integration by joining the distribution, attribute, and transaction tables along common keys, such as campaign identifier and date, to generate a single integrated tabular structure. The server performs indicator calculation by computing derived metrics such as click-through rate, conversion rate, cost per acquisition, and return on advertising spend as additional columns.

The server constructs a set of features from the preprocessed tabular data. The server includes, as features, numerical representations of bid levels, budget allocation ratios, counts of impressions and clicks, and encoded attributes of audiences and devices, as well as time-related features such as hour-of-day, day-of-week, and week-of-year indices. The server may also include interaction features obtained by combining base features, for example a feature representing the interaction between device type and time-of-day, or between region and bid level. By organizing features in this structured manner, the server reduces redundancy and improves cache locality during model training and inference, which contributes to faster processing.

The server uses the machine learning module to construct a prediction model from the features and performance indicators. In one embodiment, the server employs a tree-based ensemble algorithm, such as a random forest or gradient boosting regressor, implemented in the machine learning library. The server partitions the historical data into training and validation subsets, for example using a stratified or time-based split, and trains the prediction model to minimize a loss function such as mean squared error between predicted conversions and actual conversions. The server updates model parameters, such as tree splits and leaf values, by iteratively evaluating candidate splits that maximize information gain or reduce variance. In another embodiment, the server uses a neural-network-based prediction model, such as a multi-layer perceptron with fully connected layers, rectified linear activation functions, and an output layer producing a continuous prediction of a performance indicator. In this case, the server performs forward propagation to compute outputs, and backpropagation to compute gradients of a loss function such as mean absolute error or cross-entropy, and updates model weights using an optimization algorithm such as stochastic gradient descent or Adam.

The server defines candidate distribution conditions in a structured data format. The server generates, for each campaign scenario, a plurality of candidate configurations, each configuration including a combination of bid level, target attribute values, distribution time period patterns, and budget allocation patterns. The server enumerates or samples these combinations using a search strategy, such as grid search over discrete bid levels and time bands, or heuristic search that prioritizes ranges with historically high conversion rates. For each candidate distribution condition, the server constructs a feature vector according to the feature definitions used in the prediction model. The server passes these feature vectors to the prediction model to infer estimated performance indicators, such as expected conversions or expected revenue. The server then filters the candidates by enforcing budget conditions and constraint conditions, and selects optimal distribution conditions that maximize the performance indicator while respecting the constraints.

The server communicates the optimal distribution conditions to the terminal. The terminal displays the conditions on the touch-sensitive screen, including suggested bid levels per audience group, distribution schedules showing active hours and days, and recommended budget allocations across the distribution period. The terminal allows the user to modify the suggested conditions, for example by changing bid multipliers or adjusting the start and end dates. The terminal then sends the modified configuration back to the server.

The server uses the distribution management interface module to convert the optimal distribution conditions and user modifications into distribution setting information in the format required by the external distribution management service. The server constructs data structures representing campaigns, ad groups, targeting criteria, and bidding strategies, and transmits them through an API client library over a secure protocol. The external distribution management service, upon receiving these settings, configures its own internal systems to schedule auctions, place bids, and distribute advertisements to end users. This direct control of an external distribution platform demonstrates that the claimed system is not limited to abstract data processing, but performs concrete machine control by automatically and precisely modifying external system configurations.

The server periodically retrieves distribution result indicators from the external distribution management service. The server acquires impressions, clicks, conversions, and cost data at various granularities, such as per campaign, per ad group, and per audience segment. The server appends these newly acquired indicators to the historical information tables, thereby expanding the training dataset for future model updates. The server can schedule these retrieval operations using a job scheduler, ensuring consistent intervals and minimizing peak loads on the communication network.

The server employs a generative AI interface module to interact with a generative AI model. In one embodiment, the server accesses a generative AI model provided by a remote service implementing a transformer-based neural network language model. The generative AI model internally uses a multi-layer attention-based architecture with positional encodings, multiple self-attention heads, and feedforward sublayers. The model has been trained on large corpora of text data and can generate coherent natural-language outputs conditioned on textual inputs. The server sends prompt sentences to the generative AI model via a network API, specifying parameters such as maximum response length and sampling temperature.

The server generates prompt sentences by converting structured summary information into textual form. The server aggregates historical and recent performance indicators into concise descriptions. For example, the server may compute performance per age group and per hour-of-day and then format those statistics into text lines. The server then embeds this summary in a prompt sentence that describes the campaign objective, period, budget, and constraints, and requests specific types of optimization advice.

In one example, the server generates a prompt sentence as follows:
“Analyze the first 14 days of performance for a 30-day smartwatch advertising campaign with a 500,000 JPY total budget. The campaign targets a specific region and currently focuses on ages 25-45 interested in fitness and technology. Here is a summary of metrics by age group, region, device, and hour of day: [summary]. Based on these data, propose detailed optimizations to maximize total conversions during the remaining 16 days. Suggest specific bid changes, budget reallocations, and targeting adjustments, and explain the reasoning for each recommendation.”

In another example, the server generates a prompt sentence as follows:
“Optimize a smartwatch advertising campaign with a one-month duration and a budget of 500,000 JPY. Based on past data about smartwatch-related campaigns, propose the most effective bidding strategy, audience targeting, and daily budget allocation to maximize conversions. Provide specific, actionable recommendations.”

The server transmits such prompt sentences as plain text to the generative AI model and receives natural-language proposal content. The server then parses the proposal content to extract improvement plans. The server applies rule-based or pattern-matching techniques to identify phrases indicating adjustments, such as “increase bids for ages 25-34 by 20% in the evening,” and converts these into structured update instructions with numeric parameters and identifiers matching the internal representation of audience segments and time periods. This conversion is not a mere presentation of advice but a computational transformation from unstructured text to machine-actionable instructions that can be applied automatically. The server distinguishes between user-selected improvement plans and plans that are declined. The terminal presents the parsed improvement plans to the user, who can accept or reject them. For accepted plans, the server generates update requests for the external distribution management service, modifying existing distribution setting information, such as adjusting bid multipliers or disabling low-performing segments. The updated settings then influence future advertising distribution, which in turn modifies the real-world display of advertisements on user devices.

The server periodically performs relearning of the prediction model using the expanded historical information. In a neural-network-based embodiment, the server aggregates newly added distribution result indicators and uses them in additional training epochs. The server defines a mini-batch size and shuffles the training examples to improve generalization. The server computes a loss function comparing predicted and actual performance indicators and updates network weights through gradient descent. The server may adjust learning rates, regularization parameters, and early stopping criteria based on validation set performance. By continuously retraining the model with newly acquired data, the server adapts to changes in user behavior, seasonality, and market conditions, improving prediction accuracy and reducing error over time.

This architecture produces specific technical effects that go beyond mere automation of human decision-making. The server reduces computational load and communication overhead by generating and evaluating candidate distribution conditions in batch form rather than by trial-and-error on the external platform. The server improves storage efficiency by integrating and normalizing heterogeneous historical information into a compact feature representation, which is reused across multiple campaigns. The server enhances processing speed by using structured feature vectors and pre-trained prediction models, allowing rapid evaluation of many candidate conditions without repeated manual analysis. The server improves optimization accuracy by combining deterministic prediction modeling with generative AI-based proposal generation, where the deterministic model provides constraint-aware quantitative estimation and the generative AI model provides qualitative strategy refinements that are converted into concrete machine-level instructions.

Further, the server imposes a non-conventional processing pipeline in which generative AI is not simply consulted as a free-form advisor but is integrated into a closed-loop control system. The server automatically constructs prompt sentences from structured summaries, ensures that the prompts reflect the current state of the prediction model and distribution conditions, and enforces internal consistency by post-processing generative outputs. This non-traditional coordination between predictive modeling and generative text processing yields improved technical behavior: fewer invalid configurations submitted to the external distribution management service, fewer network round-trips caused by misconfigurations, and reduced time to convergence on effective distribution settings.

Alternative embodiments are also possible. In one alternative, the server uses a different machine learning algorithm, such as a gradient-boosted decision tree or a support vector regression model, while retaining the same structure of features and preprocessing steps. In another alternative, the generative AI model is deployed on-premises on specialized hardware, such as graphics processing units, and the server invokes the model through an internal interface rather than via an external network service. In yet another embodiment, the server represents candidate distribution conditions in a graph-based data structure and applies graph-based feature extraction prior to model inference. The same general principles—structured preprocessing, predictive evaluation of candidates, prompt-based interaction with a generative AI model, and closed-loop updates to distribution settings—are preserved across these variants.

The terminal may also vary in implementation. In one embodiment, the terminal runs a native mobile application, while in another, the terminal runs a web-based interface accessed through a browser. In both cases, the terminal's role is to relay user inputs, display optimization results, and collect the user's selections of improvement plans, while the majority of computationally intensive operations remain on the server. This division of labor ensures that even constrained devices can participate in the system while the server performs high-volume data processing and model execution.

By structuring data flows, algorithmic components, and module interactions in this manner, the system improves the operation of the underlying computer technology: it streamlines the path from raw historical records to optimized distribution settings; it reduces unnecessary network calls; it enhances prediction accuracy and computational efficiency; and it integrates a generative AI model in a technically constrained and machine-actionable way that differs from conventional, manually driven usage of such models.

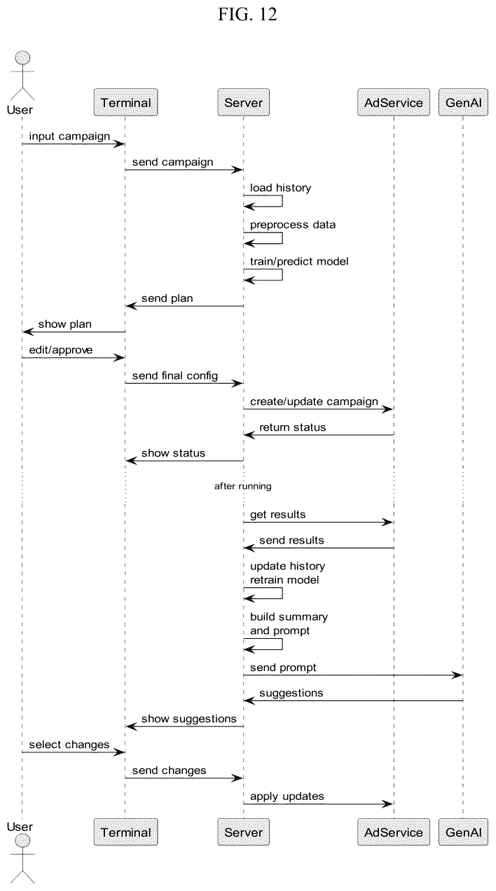

The following describes the processing flow using FIG. 12.
Step 1:

The user operates the terminal to start a new campaign configuration. The user inputs target identification information (such as a product name and category), a distribution period (start date and end date), and an allocation budget (total and optionally daily). The terminal validates these values (e.g., non-empty, valid dates, numeric budget) and, as input to the server, the terminal generates a structured request message including the user identifier, the campaign parameters, and authentication information. Based on this input, the terminal performs data serialization into a request payload and outputs a network message that is transmitted to the server over a secure communication channel.
Step 2:

The server receives the request message from the terminal. The server parses the message, verifies the authentication information, and extracts the campaign parameters as input. Based on this input, the server executes query operations against the information storage device: the server issues database queries to obtain distribution history information, attribute history information, and transaction history information associated with the target identification information and similar items. The server performs data joins and filtering in the database engine and outputs raw historical records as query result sets, which are loaded into main memory for further processing.
Step 3:

The server uses the raw historical records as input to the data acquisition and preprocessing module. The server converts the result sets into tabular data structures and analyzes each column to detect missing values, inconsistent types, and out-of-range entries. Based on this input, the server performs missing-value completion (e.g., imputing median bid levels per campaign), converts categorical values into encoded numerical vectors, integrates attributes by joining distribution, attribute, and transaction tables on common keys, and calculates indicators such as click-through rate, conversion rate, and cost per acquisition. The server outputs a cleaned and enriched tabular dataset in which each row corresponds to a past distribution condition and each column corresponds to a feature or performance indicator.
Step 4:

The server uses the cleaned and enriched tabular dataset as input to the machine learning module. The server selects specific columns as features and one or more columns as target performance indicators (e.g., conversions or revenue) and splits the dataset into training and validation partitions. Based on this input, the server trains a prediction model using a machine learning algorithm, such as a tree-based ensemble or a neural network, by iteratively adjusting model parameters to minimize a loss function between predicted and actual performance indicators. The server outputs a trained prediction model object that encapsulates learned weights, tree structures, or other model parameters suitable for inference on new candidate distribution conditions.
Step 5:

The server uses the trained prediction model and the campaign parameters from the user as input to a candidate generation module. The server enumerates or samples a plurality of candidate distribution conditions, each including a combination of bid levels, target attributes, distribution time periods, and budget allocation patterns that satisfy basic constraints (e.g., remaining within the total budget). The server transforms each candidate condition into a feature vector compatible with the prediction model and, based on these feature vectors as input, the server invokes the prediction model to estimate expected performance indicators for each candidate. The server then compares the predicted indicators under the budget and constraint conditions and outputs a set of optimal distribution conditions that maximize or optimize the selected performance indicator.
Step 6:

The server uses the optimal distribution conditions as input to a response generation module. The server structures the conditions into a response message containing details such as recommended bid levels per audience segment, recommended distribution schedules, and recommended budget allocations. Based on this structured input, the server serializes the data into a format suitable for network transmission and outputs the response message to the terminal over the communication network.
Step 7:

The terminal receives the response message from the server as input. The terminal parses the message and extracts the optimal distribution conditions. Based on this input, the terminal renders an operation screen on the display, presenting the recommended bid levels, time schedules, and audience targeting in human-readable form. The terminal allows the user to modify fields, such as adjusting bid multipliers or changing target segments, and records these modifications in a local state. The terminal outputs an updated configuration, including both the original recommendations and the user modifications, when the user confirms the settings.
Step 8:

The user reviews the optimal distribution conditions displayed on the terminal. The user uses touch gestures or other input means to edit configuration elements, such as changing a daily budget, enabling or disabling certain audience segments, or modifying the distribution period. These user actions are input to the terminal's user interface logic. Based on this input, the terminal updates the configuration values in memory, performs consistency checks (e.g., verifying that the sum of daily budgets matches the total budget), and outputs a finalized campaign configuration when the user selects an execution or save command.
Step 9:

The terminal sends the finalized campaign configuration as input to the server. The server receives this configuration and passes it to the distribution management interface module. Based on this input, the server constructs distribution setting information including campaign objects, distribution targets, bidding strategies, distribution schedules, and budget allocations in the data formats required by the external distribution management service. The server invokes an application programming interface client to send these settings to the external service. The server outputs acknowledgments and any error information back to the terminal, indicating whether the distribution settings were successfully registered or updated.
Step 10:

The server periodically uses the campaign identifiers registered with the external distribution management service as input to a performance retrieval module. The server calls the external service's reporting interface to obtain distribution result indicators, such as impressions, clicks, conversions, and costs, at specified aggregation levels. Based on this input, the server parses the received performance data, checks for completeness and consistency, and updates the historical information tables by inserting or updating rows corresponding to the new performance data. The server outputs an expanded historical dataset that includes recent distribution result indicators, which can be used as input for subsequent relearning and analysis.
Step 11:

The server uses the expanded historical dataset and the current optimal distribution conditions as input to a summary generation module. The server aggregates performance metrics by relevant dimensions, such as age group, region, device type, and time period, and computes summary statistics such as average conversion rates and costs. Based on this input, the server formats the metrics and campaign parameters into human-readable text and constructs a prompt sentence. For example, the server may output a prompt sentence such as:
“Analyze the first 14 days of performance for a 30-day smartwatch advertising campaign with a 500,000 JPY total budget. The campaign targets a specific region and currently focuses on ages 25-45 interested in fitness and technology. Here is a summary of metrics by age group, region, device, and hour of day: [summary]. Based on these data, propose detailed optimizations to maximize total conversions during the remaining 16 days. Suggest specific bid changes, budget reallocations, and targeting adjustments, and explain the reasoning for each recommendation.”
Step 12:

The server uses the prompt sentence as input to the generative AI interface module. The server transmits the prompt sentence to a generative AI model implemented as a neural network with an attention-based decoder architecture, for example via a network API. Based on this input, the generative AI model generates natural-language proposal content that includes recommended bid adjustments, target changes, time period allocation changes, and budget reallocations. The server receives this proposal content as output and forwards it to a parsing submodule.
Step 13:

The server uses the natural-language proposal content as input to the parsing submodule. The server applies rule-based extraction, pattern matching, or lightweight natural-language processing techniques to identify specific numeric recommendations and configuration changes, such as “increase bids for ages 25-34 by 20% during 18:00-23:00” or “reduce budget for non-converting regions by 30%.” Based on this input, the server maps textual references to internal identifiers for audience segments, time bands, and budget fields and converts the recommendations into structured improvement plans with explicit parameters. The server outputs a list of improvement plans, each representing a precise, machine-actionable modification of distribution setting information.
Step 14:

The terminal requests the latest improvement plans from the server and receives the structured improvement plans as input. The terminal displays the improvement plans to the user, listing each recommended change along with an explanation extracted from the proposal content. Based on this input, the user reviews the recommendations and interacts with the terminal to accept or reject individual items, for example toggling checkboxes or pressing selection buttons. The terminal outputs a subset of improvement plans that the user has explicitly accepted.
Step 15:

The terminal sends the accepted improvement plans as input to the server. The server receives this subset and passes it to the distribution management interface module. Based on this input, the server generates update requests for the external distribution management service, mapping each improvement plan to concrete modifications of distribution setting information, such as adjusting numeric bid values, changing active time periods, or reallocating budgets. The server invokes the external service's update APIs and, according to the responses, outputs confirmation messages and status information to the terminal. The server also records post-change distribution result indicators as they become available, thereby closing the loop between historical data, prediction modeling, generative AI proposal generation, user selection, and machine-level configuration updates.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented advertising management systems suffer from several technical limitations when attempting to generate and present optimized advertising distribution strategies.

First, typical systems merely retrieve historical advertising performance data and apply simple rule-based logic or static heuristic algorithms at the application layer. Such systems generally lack an integrated data processing pipeline that automatically cleans, aggregates, and transforms heterogeneous advertising, product, and sales data into machine-readable feature representations suitable for prediction and optimization. As a result, the processor is underutilized as a predictive computation engine, and the system cannot efficiently exploit large-scale historical data to improve the quality and stability of optimization results. Second, known systems often treat budget allocation and scheduling decisions as separate, sequential configurations set manually by a human operator. The processor typically does not execute a unified optimization routine that, in a single coordinated computation, searches over combinations of time periods, days of the week, device types, and user attributes while enforcing constraints on budget and campaign duration. This fragmented processing leads to suboptimal use of processing resources, unnecessary repetition of query and calculation steps, and increased latency in generating a consistent advertising distribution strategy.

Third, existing systems that integrate generative AI models are frequently designed in an ad hoc manner, where the generative AI model is invoked with loosely specified natural-language inputs that are not tightly coupled to the underlying structured optimization results. Because of this weak coupling, the generative AI model may produce explanations that are inconsistent with the computed strategy or that omit critical quantitative details. From a computer-technical perspective, the processor fails to manage and transform structured optimization outputs into prompt sentences in a systematic way, thereby limiting the reliability and reproducibility of the generated explanations.

Fourth, many systems lack a closed-loop interaction between user adjustments and the optimization engine. When a user modifies constraints, such as excluding certain time slots or changing maximum daily budget, typical systems require manual recalculation or separate configuration steps, without automatically recalculating the optimized strategy and generating updated explanatory content. This results in duplicated computations, scattered state management across components, and inefficient use of processing and storage resources. In view of the foregoing, there is a need for an improved computer-implemented system in which the processor is specifically configured to (i) acquire and preprocess advertising-related data into feature-rich, structured form, (ii) generate and evaluate prediction-based optimization candidates under explicit constraints, and (iii) produce, in a tightly integrated manner, prompt sentences and structured data for a generative AI model to generate consistent natural-language explanations. By structuring these operations as coordinated processor-executed steps, the invention aims to improve the functioning of the advertising optimization system itself, including improved data throughput, reduced computational redundancy, more stable optimization behavior, and more accurate and reliable explanatory output for the user.

The specific processing by the specific processing unit 290 of the data processing device 12 in Example 2 is realized by the following means.

The present invention provides a server comprising a processor and a storage device, the processor being configured to acquire, from the storage device, related data including advertising distribution information, product information, sales history information, and advertising effectiveness information, calculate, using the processor, click-through rates, conversion rates, and revenue indicators from the related data, and perform aggregation and feature generation based on time period, day of week, device type, and user attribute; to provide, to a terminal, a user interface that enables a user to input product identification information of an advertising target, an advertising execution period, and an advertising budget, to receive input information from the terminal, to store the input information in the storage device, and to manage the input information as constraint conditions for optimization; to generate or update, by executing a machine learning algorithm on the processor and on the basis of the related data and the input information, a performance prediction model for each advertising distribution segment, and to calculate, by using the performance prediction model, predicted numbers of conversions or predicted revenues for a plurality of advertising distribution candidate plans; to execute, on the processor, an optimization routine that searches, based on an output of the performance prediction model and on constraints including the advertising budget and the advertising execution period, for an advertising distribution strategy in which budget allocation and bid parameters for combinations of time period, day of week, device type, and user attribute are treated as variables, and to identify an optimized advertising distribution strategy that maximizes a predetermined objective function; to generate structured data representing the optimized advertising distribution strategy and key indicators serving as a basis of the optimized advertising distribution strategy, to generate, on the basis of optimization results including the structured data, a prompt sentence that instructs a generative AI model to generate an explanatory sentence and proposal content for the advertising distribution strategy, and to input the prompt sentence and the structured data to the generative AI model via a communication interface; and to receive, from the generative AI model, a natural-language explanatory sentence corresponding to the optimized advertising distribution strategy, to transmit the explanatory sentence and the optimized advertising distribution strategy to the terminal, and to cause the terminal to convert the explanatory sentence and the optimized advertising distribution strategy into a visually displayable format for presentation to the user. This enables the computing system to perform an integrated sequence of data acquisition, feature computation, prediction-based optimization, and prompt generation under explicit computational control of the processor, thereby improving system-level behavior by reducing redundant processing, enforcing consistency between structured optimization outputs and generated explanations, and providing a more efficient and technically robust mechanism for generating and updating optimized advertising distribution strategies and their natural-language descriptions.

The term “processor” refers to a hardware computation unit or a set of hardware computation units, such as a central processing unit or a graphics processing unit, configured to execute instructions and perform arithmetic and logical operations in order to implement one or more functions described herein.

The term “storage device” refers to a non-transitory computer-readable medium, such as a semiconductor memory, a magnetic storage device, or an optical storage device, configured to store data and programs used by the processor.

The term “terminal” refers to an information processing device, such as a client computer, a mobile device, or a display apparatus, configured to communicate with the server, to present a user interface to a user, and to transmit user inputs and receive outputs related to advertising distribution strategies.

The term “related data” refers to a collection of data items including at least advertising distribution information, product information, sales history information, and advertising effectiveness information, which are stored in the storage device and are used for analysis, prediction, and optimization of advertising distribution.

The term “advertising distribution information” refers to data representing the delivery of advertisements, including at least impression counts, click counts, conversion counts, and delivery conditions such as time period, day of week, device type, and user attribute.

The term “product information” refers to data describing items or services to be advertised, including at least product identifiers, product attributes, and classification information used to associate advertising performance with specific products.

The term “sales history information” refers to transactional data indicating past sales events, including at least order dates, product identifiers, quantities sold, and sales amounts associated with products for which advertisements have been distributed.

The term “advertising effectiveness information” refers to data indicating the performance of advertising activities, including at least metrics such as click-through rate, conversion rate, revenue per impression, or revenue per click, which are derived from advertising distribution information and sales history information.

The term “time period” refers to a temporal unit or interval, such as an hour of a day or a set of hours, used as a dimension for aggregating and optimizing advertising distribution.

The term “day of week” refers to a categorical time indicator specifying one of the days in a weekly cycle, used as a dimension for grouping and differentiating advertising distribution behavior.

The term “device type” refers to a classification of client devices on which advertisements are displayed, such as a mobile device, a desktop device, or a tablet device, used as a dimension for targeting and optimizing advertising distribution.

The term “user attribute” refers to a characteristic of an end user or a user segment, such as demographic information, interest category, or behavioral segment, used to define target audiences and to differentiate advertising distribution strategies.

The term “user interface” refers to a graphical or interactive presentation, such as a web page or an application screen, through which a user can input product identification information, an advertising execution period, and an advertising budget, and can view an optimized advertising distribution strategy and explanatory information.

The term “product identification information” refers to data that uniquely identifies a product or service to be advertised, such as a product code or a catalog identifier, used by the system to associate advertising performance and sales history with a specific product.

The term “advertising execution period” refers to a time interval, specified by a start point and an end point, during which an advertising campaign is to be executed and for which an optimized advertising distribution strategy is generated.

The term “advertising budget” refers to a monetary amount or value limit allocated by a user for an advertising campaign, used as a constraint in the optimization of advertising distribution.

The term “constraint conditions” refers to limitations or requirements, including at least the advertising execution period and the advertising budget, and optionally additional user-specified restrictions, which must be satisfied by an optimized advertising distribution strategy.

The term “advertising distribution segment” refers to a unit of advertising delivery defined by a combination of attributes such as time period, day of week, device type, and user attribute, for which performance is predicted and optimized.

The term “machine learning algorithm” refers to a computational method, such as a neural network, a regression model, or a decision tree-based model, that is trained on related data to learn patterns and generate a performance prediction model for advertising distribution segments.

The term “performance prediction model” refers to a trained machine learning model that, for a given advertising distribution segment and associated features, outputs a predicted performance measure, such as a predicted number of conversions or a predicted revenue.

The term “advertising distribution candidate plan” refers to a hypothetical configuration of advertising distribution, including proposed budget allocation and bid parameters across advertising distribution segments, whose performance is evaluated using the performance prediction model.

The term “optimization routine” refers to a sequence of computational steps executed by the processor to search over a space of advertising distribution candidate plans, under constraint conditions, in order to identify an optimized advertising distribution strategy.

The term “objective function” refers to a mathematical function defined over candidate advertising distribution strategies, such as a function of predicted conversions or predicted revenue, that is to be maximized or minimized by the optimization routine.

The term “optimized advertising distribution strategy” refers to an advertising distribution strategy identified by the optimization routine as optimizing the objective function while satisfying the constraint conditions, including specific budget allocation and bid parameters for advertising distribution segments.

The term “structured data” refers to data organized in a predefined format, such as a record, table, or hierarchical structure, representing the optimized advertising distribution strategy and key indicators used as a basis for explanation and further processing.

The term “key indicators” refers to quantitative measures related to the optimized advertising distribution strategy, such as expected conversions, expected revenue, predicted click-through rates, and predicted conversion rates, that serve as a basis for evaluation and explanation.

The term “prompt sentence” refers to a machine-readable textual instruction, generated by the processor, that is provided to a generative AI model to cause the generative AI model to generate a natural-language explanatory sentence and proposal content regarding an advertising distribution strategy.

The term “generative AI model” refers to a trained computational model, such as a large language model, that generates natural-language text in response to an input prompt sentence and optionally associated structured data.

The term “explanatory sentence” refers to a natural-language text generated by the generative AI model that describes, interprets, or justifies an optimized advertising distribution strategy, including budget allocation, bid parameters, and expected performance measures.

The term “proposal content” refers to natural-language or structured output generated by the generative AI model that includes recommendations or suggested actions regarding an advertising distribution strategy, based on the optimization results.

The term “visually displayable format” refers to a data format, such as a layout of text, tables, and graphical elements, that can be rendered on a display device of the terminal so that a user can visually perceive and understand the optimized advertising distribution strategy and the explanatory sentence.

In one embodiment, a server cooperates with at least one terminal operated by a user to implement the claimed system. The server includes a processor, a main memory, a non-transitory storage device, and a network interface. The processor is, for example, a multi-core central processing unit and may be combined with an auxiliary graphics processing unit for accelerating matrix operations. The storage device is, for example, a magnetic disk device, a solid-state drive, or a network-attached storage device. The network interface connects the server to the terminal over a packet-based network such as the Internet.

A terminal is, for example, a personal computer, a tablet, or a smartphone that includes a display device, an input device, and a communication unit. The terminal executes a client application, such as a web browser or a native application, that communicates with the server using a communication protocol such as HTTPS. The user operates the terminal to input information and to view optimized advertising distribution strategies and corresponding explanations.

The server stores, in the storage device, related data including advertising distribution information, product information, sales history information, and advertising effectiveness information. The server uses a database management system such as a relational database engine to manage these data sets in structured form. The server maintains, for example, an advertising performance table storing, per advertising distribution segment, fields such as a product identifier, a time period, a day of week, a device type, a user attribute, an impression count, a click count, a conversion count, and a revenue amount. The server maintains a product table storing, for each product, a product identifier, a category, and attribute information. The server maintains a sales history table storing, for each order, an order date, a product identifier, a quantity, and a monetary value.

The server uses a data processing library, such as a numerical computation library and a data frame processing library, to perform data transformations on the related data in the main memory. The server reads rows from the database tables into internal data structures and calculates advertising effectiveness information such as click-through rate, conversion rate, and revenue per impression by performing arithmetic operations on impression counts, click counts, conversion counts, and revenue amounts. The server aggregates the related data by grouping keys such as the time period, the day of week, the device type, and the user attribute, and the server computes, for each group, sums and averages of relevant metrics. The server then generates feature vectors for each advertising distribution segment by encoding categorical variables into numerical form, such as one-hot encoding for the day of week and the device type, and by normalizing continuous variables using scaling procedures such as min-max scaling or standardization.

The server provides a user interface to the terminal by generating user interface definitions, such as markup and script resources, and transmitting these to the terminal. The terminal displays, on the display device, an input screen that includes fields for product identification information, an advertising execution period, and an advertising budget. The user enters the product identification information, such as a product code, specifies the advertising execution period, such as a start date and an end date, and sets an advertising budget, such as a monetary amount. The terminal transmits these inputs to the server using the communication unit. The server receives the inputs, validates them according to predefined rules, and stores them as campaign records in the database, where they are used as constraint conditions for subsequent optimization.

The server uses a machine learning algorithm to construct and maintain a performance prediction model. In one embodiment, the server implements a feed-forward neural network using a numerical computation framework. The server defines an input layer whose size corresponds to the number of features representing an advertising distribution segment, for example, indicators for day of week, time of day, device type, user segment, historical impressions, historical click-through rate, historical conversion rate, and an expected budget allocation variable. The server defines one or more hidden layers with a predetermined number of units, for example, 64 or 128 units per layer, and uses an activation function, such as a rectified linear unit, to introduce non-linearity. The server defines an output layer with one or more outputs, such as a single node representing an expected number of conversions or an expected revenue value.

The server trains the neural network using historical related data. The server partitions the data into a training set and a validation set, and the server defines a loss function, such as a mean squared error for revenue prediction or a Poisson loss for predicting conversion counts. The server performs gradient-based optimization by repeatedly computing, in the processor or the graphics processing unit, forward passes and backward passes on mini-batches of feature vectors and target labels. The server updates network weights using an optimization algorithm such as stochastic gradient descent with momentum or an adaptive learning-rate method. The server monitors the loss on the validation set and may apply an early stopping procedure to prevent overfitting. The server stores the trained model parameters in the storage device for later inference.

The server applies the trained performance prediction model to evaluate multiple advertising distribution candidate plans. The server generates candidate plans by assigning budget allocations and bid parameters to combinations of time period, day of week, device type, and user attribute, while maintaining compliance with the advertising budget and the advertising execution period constraints. For each candidate plan, the server constructs a set of feature vectors that combine the historical features of each advertising distribution segment with the proposed budget and bid parameters. The server maps these feature vectors through the neural network by performing matrix multiplications and non-linear activations, thereby obtaining predicted conversions or predicted revenue for each segment and for the candidate plan as a whole.

The server executes an optimization routine that operates on the predicted performance metrics. The server defines an objective function, for example, the total predicted number of conversions under the budget constraint, and computes the objective function value for each candidate plan. The server uses a search method, which can include heuristic search, grid search over parameter ranges, or more advanced procedures such as Bayesian optimization, to explore the space of candidate plans. The server prunes candidate plans that violate the budget constraint or other user-specified constraints, such as a maximum bid threshold. By iteratively evaluating candidate plans using the performance prediction model and comparing objective function values, the server identifies an optimized advertising distribution strategy that maximizes the objective function while satisfying the constraints.

The server generates structured data representing the optimized advertising distribution strategy. The structured data includes, for each advertising distribution segment, values for the time period, the day of week, the device type, the user attribute, an allocated budget, a bid parameter, and the predicted performance metrics. The server also computes key indicators, such as an expected total number of conversions and an expected total revenue for the entire advertising execution period, and stores these values together with the structured data in a data record.

The server prepares a prompt sentence for a generative AI model on the basis of the structured data and the key indicators. The server transforms the structured data into a textual summary that is machine-readable and logically consistent, and combines it with instruction text that defines the role and task of the generative AI model. For example, the server may generate the following prompt sentence:
“You are an advertising optimization assistant. Based on the following optimized allocation for an advertising campaign, explain in clear and concise English how the budget is distributed across days of the week, hours of the day, and device types. Also explain why focusing on certain time slots is expected to increase conversions by approximately 20 percent. The allocation concentrates 70 percent of the total budget on weekdays between 6 p.m. and 9 p.m., primarily on mobile devices, where historical click-through rate and conversion rate are highest. Please describe the recommended budget allocation and bid adjustments, and summarize the expected number of conversions.”

In another example, the server may generate a more detailed prompt sentence:
“You are a marketing data analyst. Using the following campaign conditions and performance summary, generate a detailed 2-week advertising plan with a budget of 2,000,000 units of currency. The historical data indicate that weekday evenings from 18:00 to 21:00 on mobile devices have a click-through rate that is 1.5 times higher and a conversion rate that is 1.4 times higher than the daily average. The optimized strategy allocates 70 percent of the budget to these segments and 30 percent to other segments. Explain why this allocation maximizes expected conversions and how many conversions are expected compared with a uniform budget distribution.”

The server provides the prompt sentence and the structured data as inputs to the generative AI model. The generative AI model is, for example, a large language model parameterized by a multi-layer transformer architecture that has been trained in advance on a large text corpus. The server transmits the prompt sentence and the structured data through an application programming interface to the generative AI model, which executes sequence-processing operations to generate a natural language explanatory sentence and proposal content. The server receives the generated text and associates it with the corresponding optimized advertising distribution strategy.

The server transmits both the optimized advertising distribution strategy and the explanatory sentence to the terminal. The terminal renders the received information on the display device by presenting, for example, a tabular view of budget allocation and bid parameters per segment, graphical charts depicting budget allocation across time periods and device types, and a textual block that describes the rationale and the expected performance benefits. The user can readily understand how the campaign budget is distributed and why these settings are calculated to improve advertising effectiveness, without manually analyzing the underlying raw data.

In this configuration, the server does not merely automate a human cognitive process but alters the way in which data is organized, processed, and communicated within the computing environment. The server improves computing performance by precomputing feature representations and by using a trained neural network model to predict performance metrics, thereby reducing the need for repeated ad-hoc database queries and manual analysis. The server improves accuracy of predictions by tailoring the performance prediction model to segment-level features that a human operator would not reasonably handle in real time, and by applying gradient-based training and validation procedures that systematically reduce prediction error. The server improves resource utilization by executing an optimization routine that focuses computation on promising candidate plans and prunes infeasible or low-yield strategies early, which reduces the number of model inferences and database operations. The server also improves the consistency and reliability of communication with the generative AI model by generating prompt sentences that are tightly coupled to the structured optimization results. Because the server enforces a specific mapping between data fields in the structured data and phrases in the prompt sentence, the generative AI model receives a technically grounded description of the optimization outcome, which reduces the likelihood of inconsistent or irrelevant generated text. This tight coupling is different from conventional ad hoc prompt generation, in which unstructured human-written descriptions may not reflect the current optimization state.

The server uses internal rules and processing flows that are not simple codifications of human decision-making. For example, the server orders feature importance by computing, from the trained model, contributions of different features to prediction outcomes, and may adjust search ranges or candidate plan sampling densities according to the computed feature importance. The server can bias the optimization routine to explore more combinations in regions of high sensitivity and fewer combinations elsewhere, thereby achieving a non-linear improvement in search efficiency that a human operator does not achieve by manual trial-and-error.

In one alternative embodiment, the server uses a different machine learning algorithm, such as a gradient-boosted decision tree ensemble, instead of a neural network. In this case, the server constructs decision trees based on feature splits that maximize information gain or reduction in prediction error, and the server aggregates predictions from multiple trees to compute expected conversions or revenue. The rest of the architecture, including the optimization routine and the prompt generation, remains substantially similar. Because the tree-based model may be more interpretable for some data distributions, the server can extract specific conditions, such as “weekday evenings on mobile devices,” directly from the model structure and include them explicitly in the prompt sentence.

In another embodiment, the server configures the optimization routine to minimize a communication load between the server and external advertising platforms. The server clusters advertising distribution segments into groups that share similar feature values and performance characteristics and assigns common bid and budget adjustments to each cluster. By reducing the number of distinct configuration changes that must be transmitted to external systems, the server reduces the frequency and volume of configuration messages, which lowers network traffic and improves reliability of campaign deployment.

In another embodiment, the server maintains a versioned set of performance prediction models and periodically retrains the models as new related data are collected. The server uses incremental training methods where the model parameters are updated using batches of the most recent historical data and regularization techniques such as L2 weight decay to prevent model drift. The server may monitor degradation in prediction accuracy over time and automatically schedule retraining when the degradation exceeds a threshold. This configuration improves long-term prediction stability and ensures that the optimization routine is consistently informed by up-to-date patterns in user behavior and advertising performance.

In another embodiment, the server uses data augmentation techniques when training the performance prediction model. The server introduces slight perturbations to features, such as noise on time-of-day boundaries or simulated small changes in bid levels, to increase the robustness of the model against minor fluctuations in campaign settings. Because these perturbations expand the effective training data coverage, the server obtains a model that generalizes better to unseen campaign scenarios, thereby reducing prediction error and improving optimization reliability.

In another embodiment, the server uses multiple generative AI models for different purposes. The server can use a first generative AI model specialized in concise summaries and a second generative AI model specialized in detailed technical explanations. The server can generate distinct prompt sentences for each model, based on the same structured data, and present both a brief overview and an in-depth rationale on the terminal. This division of roles allows the server to tailor explanation complexity to different users without changing the underlying optimization process.

Through these and other embodiments, the server, the terminal, and the user cooperate so that the server executes specific data transformations, prediction computations, and optimization procedures that improve the internal operation of the advertising optimization system. The server uses structured feature engineering, trained models, and constrained optimization routines that are not merely direct translations of human mental processes. Instead, the server transforms the way data is represented and searched within the computing environment, resulting in improved prediction accuracy, reduced computation time, more efficient memory and network usage, and more reliable and consistent generation of natural-language explanations via the generative AI model and the prompt sentence generation mechanism.

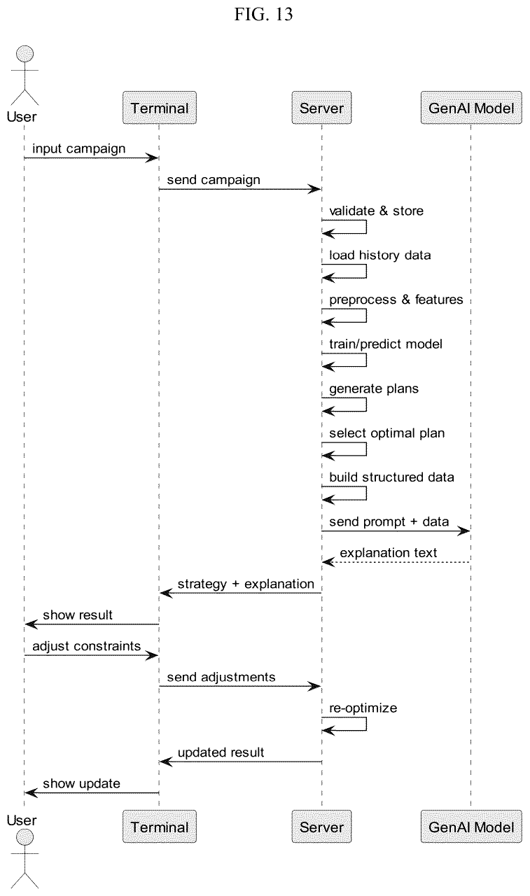

The following describes the processing flow using FIG. 13.
Step 1:

User operates the terminal to access an advertising management screen provided by the server.

User inputs product identification information, an advertising execution period, and an advertising budget through input fields displayed on the terminal.

Terminal receives these input values, performs basic validation such as checking that mandatory fields are not empty and that dates have a valid order, and packages the values into a structured request.

Input: Raw user inputs (product code, start date, end date, budget amount) from the terminal UI.

Terminal converts the raw user inputs into a structured message, for example by mapping each input field to a key-value pair, and sends this message to the server over a secure network connection.

Output: A formatted request message containing validated campaign conditions transmitted to the server.
Step 2:

Server receives the request message containing the campaign conditions from the terminal via a network interface.

Server validates the received data using internal rules, such as verifying that the product identification information exists in a product master table, that the advertising execution period does not exceed a configured maximum duration, and that the advertising budget falls within permissible limits.

Input: Structured campaign condition message (product identification information, execution period, budget) from the terminal.

Server, based on the input, performs data type checks, range checks, and referential integrity checks against stored product records, and identifies invalid or missing values. If validation succeeds, the server writes a new campaign record into a campaign table in a database and assigns a unique campaign identifier.

Output: A stored campaign record with a unique campaign ID and normalized campaign parameters.
Step 3:

Server retrieves related data needed for optimization from the storage device using the campaign record as a reference.

Server queries advertising distribution information, product information, sales history information, and previously calculated advertising effectiveness information from one or more database tables associated with the product identification information and a relevant historical period.

Input: Campaign record including product identification information and possibly a historical reference period defined by the server.

Server executes database queries that filter rows by product identifier and date range, then loads the result sets into in-memory data structures, such as tables or arrays, for further processing.

Output: Raw historical data sets including impression counts, click counts, conversion counts, revenues, and associated contextual attributes (time period, day of week, device type, user attribute).
Step 4:

Server preprocesses the retrieved historical data to generate feature-rich representations for each advertising distribution segment.

Server cleans the data by removing or correcting inconsistent rows (for example, rows where conversion counts exceed click counts) and handles missing values by applying default values or imputation strategies.

Input: Raw historical data sets from the database.

Server aggregates records by grouping keys such as time period, day of week, device type, and user attribute, and calculates aggregated metrics including total impressions, total clicks, total conversions, and total revenue for each group. Server computes derived metrics such as click-through rate, conversion rate, and revenue per impression by performing arithmetic operations on the aggregated metrics. Server encodes categorical attributes into numerical form, scales continuous attributes, and arranges all attributes into feature vectors representing advertising distribution segments.

Output: A feature matrix and associated labels or target values suitable for machine learning, each row corresponding to one advertising distribution segment.
Step 5:

Server constructs or updates a performance prediction model using a machine learning algorithm applied to the feature matrix.

Server divides the historical feature matrix and target values into a training set and a validation set according to predefined ratios.

Input: Preprocessed feature matrix and target values such as historical conversion counts or revenue values.

Server initializes model parameters for a prediction model, such as neural network weights, and repeatedly performs forward propagation and backpropagation on training batches. During forward propagation, the server calculates intermediate activations and output predictions by executing matrix multiplications and non-linear activation functions. During backpropagation, the server computes gradients of a loss function (for example, mean squared error between predicted and actual conversions) with respect to each parameter and updates the parameters using an optimization algorithm. The server tracks validation loss and may stop training when improvement falls below a threshold.

Output: A trained performance prediction model stored in memory or in the storage device, ready to be used for inference.
Step 6:

Server generates multiple advertising distribution candidate plans that satisfy basic constraints derived from the campaign conditions.

Server constructs candidate plans by assigning different combinations of budget allocation percentages and bid parameters across time periods, days of the week, device types, and user attributes, while ensuring that total allocated budget does not exceed the campaign budget. Input: Campaign record (constraints on total budget and execution period) and possibly configuration parameters defining search ranges for budget percentages and bid multipliers.

Server programmatically enumerates or samples candidate plans by iterating over discrete values of time slots, device types, and user attributes, and by assigning budget shares and bid adjustments according to preconfigured patterns or search strategies.

Output: A set of candidate plans, each represented as structured data describing proposed allocations and bid parameters per advertising distribution segment.
Step 7:

Server evaluates each candidate plan using the trained performance prediction model to estimate expected performance.

Server, for each segment in each candidate plan, constructs an input feature vector by combining static historical features (such as typical click-through rate) with dynamic campaign features (such as proposed budget allocation and bid parameter for that segment).

Input: Set of candidate plans and the trained performance prediction model.

Server feeds each feature vector into the performance prediction model, which outputs a predicted metric, such as an expected conversion count or expected revenue, for that segment. Server aggregates these predictions per candidate plan by summing or averaging the segment-level predictions, thereby computing an overall predicted performance measure for each plan. Output: A list of candidate plans annotated with predicted performance metrics, such as total expected conversions and total expected revenue.
Step 8:

Server executes an optimization routine over the evaluated candidate plans to identify an optimized advertising distribution strategy.

Server defines an objective function, for example maximizing the total expected conversions under the budget and period constraints, and compares the predicted performance metrics among all candidate plans.

Input: Candidate plans with associated predicted performance metrics, plus constraint conditions derived from the campaign record.

Server selects the plan that yields the best objective function value among all feasible plans. If the optimization routine is iterative, the server may generate refined candidate plans in promising regions and re-evaluate them using the performance prediction model until a convergence criterion is met.

Output: A single optimized advertising distribution strategy, or a small set of near-optimal strategies, represented as structured data.
Step 9:

Server generates structured data and key indicators representing the optimized advertising distribution strategy.

Server extracts segment-level information, such as time periods, days of the week, device types, user attributes, allocated budgets, and bid parameters, and couples this with predicted metrics such as expected conversions per segment and total expected conversions.

Input: Optimized advertising distribution strategy from the optimization routine.

Server arranges these values into a hierarchical or tabular structure, for example a list of segment records, each containing configuration parameters and performance predictions, and computes aggregate indicators such as overall expected revenue and uplift compared with a baseline.

Output: Structured strategy data and key indicators suitable for storage, display, and use in prompt generation.
Step 10:

Server constructs a prompt sentence for a generative AI model using the structured data and key indicators.

Server converts quantitative fields from the structured strategy data into descriptive text fragments and embeds them in an instruction template that specifies the role of the generative AI model and the type of explanation to be generated.

Input: Structured strategy data and key indicators produced in Step 9.

Server composes a natural language prompt sentence, such as:
“You are an advertising optimization assistant. Based on the following optimized advertising distribution strategy for a campaign, explain how the budget is allocated across days, time periods, and device types, and why focusing on weekday evenings from 18:00 to 21:00 on mobile devices is expected to increase conversions by approximately 20 percent compared with a uniform allocation. The strategy allocates 70 percent of the total budget to weekday evenings on mobile devices and 30 percent to other periods and devices. Please describe the recommended allocation, the rationale, and the expected number of conversions.”

Server sends this prompt sentence, optionally together with a textual summary of the structured data, to the generative AI model through an interface.

Output: A prompt sentence and associated contextual text transmitted to the generative AI model.
Step 11:

Server receives a natural-language explanatory sentence and proposal content from the generative AI model in response to the prompt sentence.

Server parses the generated text to confirm that it meets format expectations, such as including a summary section and recommendation section, and may perform basic quality checks or sanitization.

Input: Generated text output returned by the generative AI model.

Server associates the generated explanatory text with the corresponding optimized advertising distribution strategy by storing both in related records or by combining them into a response object to be sent to the terminal.

Output: A combined result consisting of the optimized advertising distribution strategy and the corresponding explanatory text.
Step 12:

Server transmits the combined result, including the optimized advertising distribution strategy and the explanatory text, to the terminal.

Terminal receives the result, decomposes it into configuration data and text content, and maps each part to user interface components.

Input: Response object from the server containing structured strategy data and natural-language explanation.

Terminal renders tables that present, for each advertising distribution segment, the allocated budget, bid parameters, and predicted performance, and displays the explanatory text in a readable layout. Terminal may also generate charts showing budget distribution over time and across device types.

Output: A visual presentation on the terminal display that allows the user to understand the optimized strategy and its rationale.
Step 13:

User reviews the displayed optimized advertising distribution strategy and the explanatory text on the terminal.

User may decide to modify constraints, such as lowering the maximum daily budget, excluding certain late-night time periods, or prioritizing desktop devices instead of mobile devices.

Input: On-screen representation of the optimized strategy and explanation presented by the terminal.

User enters adjustment commands via the terminal's input interface, and the terminal sends these adjustments as new constraint data back to the server. These new inputs can trigger a repetition of the preceding steps (from data retrieval or candidate generation), allowing the server to recompute an updated optimized strategy under modified constraints.

Output: Updated constraint information transmitted to the server, which serves as new input for further optimization processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional digital distribution systems, such as advertising or information delivery platforms, several technical limitations arise from the way computing resources are used to design, configure, and adapt distribution strategies. First, server-side components typically rely on static rule sets or manually tuned parameters to determine bids, schedules, and targeting conditions. As a result, the server does not efficiently exploit large volumes of heterogeneous data (for example, historical delivery logs, item attributes, and result metrics) to generate optimized distribution policies. This leads to sub-optimal usage of processor time, memory, and network resources because the system repeatedly executes non-adaptive logic and requires significant operator intervention.

Second, existing systems that incorporate machine learning components tend to confine such components to isolated prediction tasks. The server often treats a predictive model as a black box and does not integrate it with dynamic prompt generation for generative artificial intelligence models. In such architectures, the processor does not automatically transform structured analysis results into prompt sentences in natural language, and therefore cannot systematically leverage generative models to synthesize complex distribution policies and content variants. This separation forces the processor to execute multiple disjoint processing pipelines and prevents end-to-end optimization of the data flow.

Third, generative artificial intelligence models, when used, are typically driven by manually written prompts that are not derived from machine-readable data structures or model outputs. The processor therefore cannot automatically produce context-rich prompt sentences that reflect current budget constraints, temporal patterns, or spatial performance differences learned from historical data. As a result, the generative models produce content that is poorly aligned with real-time optimization needs, causing unnecessary iterations and increased latency in the distribution pipeline.

Fourth, many existing systems do not effectively acquire and use user state information, such as emotion inferred from visual and audio signals, as a first-class input to distribution logic. Emotion recognition, if present at all, is often implemented as an auxiliary feature. The processor does not maintain a structured correspondence between emotion data and distribution policy parameters or generated content, and does not feed this correspondence back into model training or prompt construction. This limits the ability of the computing system to adapt distribution policies and content generation in real time based on detected user states and degrades responsiveness and personalization at the system level.

Fifth, conventional systems do not close the loop between external distribution platforms, terminal devices, and server-side optimization logic in a unified, continually learning architecture. Display history information, response history information, and user emotion information are often stored in separate silos and not accumulated as a single training history. Consequently, the processor cannot periodically update both the estimation model and the prompt sentence generation logic in a coordinated fashion. This leads to models that drift from current conditions, prompt construction routines that remain static, and overall inefficiencies in resource usage and distribution performance.

Accordingly, there is a need for a computing architecture in which a processor automatically acquires and preprocesses heterogeneous related information, constructs and updates an estimation model, generates structured distribution control parameters under resource constraints, automatically composes prompt sentences for a generative artificial intelligence model, and integrates user state information, including emotion, into both policy optimization and content generation. Such a system should reduce manual configuration, improve the efficiency and accuracy of server-side decision making, and enhance the responsiveness of the entire distribution pipeline, thereby improving the functioning of the computer system itself.

The specific processing by the specific processing unit 290 of the data processing device 12 in Application Example 2 is realized by the following means.

The present invention provides a server comprising a processor configured to acquire, from a storage device, related information including distribution-related information, item-related information, and result-related information; to integrate the related information and perform preprocessing including completion of missing values, removal of abnormal values, normalization, and numerical conversion of categorical information to generate a preprocessed data set; to construct, based on the preprocessed data set, a trained estimation model using a prediction algorithm and to search, by using the trained estimation model, distribution control parameters including bid values, distribution time periods, and distribution areas under a constraint of resource allocation information to derive optimized distribution policy information; to generate, based on target identification information, a distribution period, the resource allocation information, and the optimized distribution policy information, a prompt sentence in a natural language that instructs a content generation algorithm to generate distribution policy information and expression content information; to input the prompt sentence to a generative artificial intelligence model and to store, in association with the optimized distribution policy information, distribution policy information and expression content information obtained from the generative artificial intelligence model; to transmit the distribution policy information and the expression content information as display data to a terminal device, to receive confirmation and correction input from a user via the terminal device, and to update the distribution policy information and the expression content information based on the correction input; to transmit, to an external distribution platform, distribution setting information corresponding to the updated distribution policy information and the expression content information and to cause the external distribution platform to start a distribution process; to receive user state information from the terminal device, to specify user emotion information using an emotion estimation algorithm, and to record a correspondence between the user emotion information and the distribution policy information and the expression content information; and to generate, based on the user emotion information and the correspondence, an emotion-dependent prompt sentence to be input to the generative artificial intelligence model, to cause the generative artificial intelligence model to generate additional emotion-dependent expression content information or recommendation target information using the emotion-dependent prompt sentence, and to update the distribution policy information in real time. This enables the server to implement an integrated, closed-loop optimization pipeline in which heterogeneous historical and real-time data are transformed into structured model inputs, into context-rich prompt sentences, and into dynamically updated policy and content outputs, thereby improving computational efficiency, reducing manual configuration, enhancing adaptability to user state, and overall improving the functioning of the computer system that executes distribution processes.

The term “processor” refers to a hardware or virtual computation unit, such as a central processing unit or execution core, that is configured to execute instructions and perform the described data acquisition, preprocessing, model construction, optimization, prompt generation, and communication functions.

The term “storage device” refers to a hardware component or logical storage resource, such as a database system or memory subsystem, that is configured to store and provide access to distribution-related information, item-related information, result-related information, and training history.

The term “distribution-related information” refers to information representing operational parameters and outcomes of past or current delivery activities, including but not limited to impression logs, exposure times, delivery channels, targeting parameters, and platform settings.

The term “item-related information” refers to information describing an object to be delivered or promoted, including but not limited to identifiers, categories, attributes, descriptive data, and pricing data for goods, services, or content.

The term “result-related information” refers to information indicating responses or outcomes produced by distribution activities, including but not limited to clicks, conversions, purchases, user actions, revenue amounts, and engagement metrics.

The term “storage device from which related information is acquired” refers to any persistent or semi-persistent data repository, such as a relational database, key-value store, or file system, that stores distribution-related information, item-related information, and result-related information in a machine-readable format.

The term “input/output interface” refers to a software and hardware combination, such as a graphical user interface, application programming interface, or web form, that enables a user or terminal apparatus to provide target identification information, distribution periods, and resource allocation information to the processor and to receive output information.

The term “target identification information” refers to information that uniquely or collectively identifies a distribution target, such as an item, content, or campaign, including but not limited to product codes, item identifiers, or campaign identifiers.

The term “distribution period” refers to a time interval during which distribution of content, items, or information is scheduled or permitted, including start times, end times, and optionally periodic or recurring patterns.

The term “resource allocation information” refers to information indicating constraints or budgets for distribution activities, including but not limited to financial budgets, impression caps, bid limits, and other quantitative resource limits.

The term “preprocessed data set” refers to data obtained by integrating and transforming raw related information through operations such as completion of missing values, removal of abnormal values, normalization of numerical values, and numerical conversion of categorical information, such that the data is suitable for use by machine learning or estimation algorithms.

The term “completion of missing values” refers to an operation in which absent or undefined data elements in the related information are replaced with estimated or default values according to predetermined rules or statistical methods.

The term “removal of abnormal values” refers to an operation in which data records or elements identified as outliers or inconsistent with expected ranges or patterns are excluded or corrected in accordance with predetermined criteria.

The term “normalization” refers to an operation that scales or transforms numerical values, for example to a common range or distribution, to facilitate stable training or execution of estimation models.

The term “numerical conversion of categorical information” refers to a transformation in which non-numeric categorical values, such as labels, classes, or codes, are mapped to one or more numeric values, for example through one-hot encoding or embedding, so that the values can be processed by numerical algorithms.

The term “prediction algorithm” refers to a computational procedure, such as a machine learning algorithm or statistical model, that is designed to estimate values of performance indicators or other variables based on input features derived from the preprocessed data set.

The term “trained estimation model” refers to a prediction model whose internal parameters have been determined by applying a prediction algorithm to a training portion of the preprocessed data set, so that the model can estimate performance indicators for new or hypothetical conditions.

The term “performance indicators” refers to quantitative measures used to evaluate distribution performance, including but not limited to click-through rate, conversion rate, expected revenue, cost per action, and other efficiency or effectiveness metrics.

The term “distribution control parameters” refers to adjustable variables that influence how distribution is executed, including but not limited to bid values, distribution time periods, distribution areas, audience segments, and device types.

The term “bid values” refers to numerical values indicating offers or maximum amounts that a distribution system is willing to expend per impression, click, conversion, or similar unit in a bidding-based distribution environment.

The term “distribution time periods” refers to one or more specific time windows, such as hours of day or days of week, designated for executing or prioritizing distribution activities.

The term “distribution areas” refers to geographical or logical regions in which distribution is enabled or targeted, including but not limited to countries, cities, zones, or network regions.

The term “optimized distribution policy information” refers to information describing distribution control parameters that have been selected or derived to optimize at least one performance indicator under one or more constraints, including resource allocation information.

The term “content generation algorithm” refers to a computational procedure that generates text, images, or other forms of media content in response to one or more input conditions or instructions.

The term “prompt sentence” refers to a sequence of natural language tokens or structured text that encodes instructions, context, and constraints for a generative artificial intelligence model, and that is designed to elicit specific policy information or expression content from the model.

The term “generative artificial intelligence model” refers to a trained computational model capable of generating new content, such as text, images, or structured plans, in response to input data or prompt sentences, typically by using statistical or machine learning methods.

The term “distribution policy information” refers to information specifying rules, strategies, or configurations for distributing content or items, including but not limited to schedules, targeting criteria, and bid strategies.

The term “expression content information” refers to information describing content used in distribution, including but not limited to textual messages, graphical elements, audio elements, or multimedia components intended for presentation to users.

The term “display data” refers to content and associated presentation parameters that are formatted for rendering on a display apparatus or terminal device, such as text strings, image data, layout information, and metadata.

The term “terminal device” refers to an end-user computing apparatus, such as a mobile device, tablet, personal computer, or similar hardware, configured to send and receive data to and from the server, display content, and capture user input.

The term “external distribution platform apparatus” refers to an external computing system or service that receives distribution setting information and executes distribution of content, such as an advertising network, content delivery system, or third-party distribution platform.

The term “distribution setting information” refers to configuration data transmitted to an external distribution platform apparatus that indicates how the distribution platform should execute a distribution process, including campaign settings, bid parameters, schedules, and targeting criteria.

The term “distribution process” refers to a sequence of operations executed by a distribution platform, including selecting recipients, scheduling exposures, bidding for opportunities, serving content, and recording results.

The term “visual acquisition unit” refers to a component of a terminal device, such as a camera or image sensor, configured to acquire visual information representing a user's face, body, or environment.

The term “audio acquisition unit” refers to a component of a terminal device, such as a microphone or audio sensor, configured to acquire audio information representing a user's speech, sounds, or environment.

The term “user state information” refers to information representing one or more aspects of a user's current condition, including but not limited to visual features, audio features, interaction patterns, and derived emotion labels.

The term “emotion estimation algorithm” refers to a computational procedure, implemented for example by a machine learning model, that processes user state information to infer one or more emotional states, such as joy, sadness, calmness, or excitement.

The term “user emotion information” refers to output data produced by an emotion estimation algorithm, indicating an inferred emotional state of a user and optionally including confidence scores or other related metrics.

The term “correspondence between user emotion information and distribution policy information and expression content information” refers to a stored association or mapping that links specific user emotion information with particular distribution policies and content variants that were presented under those emotions.

The term “emotion-dependent prompt sentence” refers to a prompt sentence that explicitly encodes information about a user's emotional state and that is designed to cause a generative artificial intelligence model to generate content or policies adapted to that emotional state.

The term “emotion-dependent expression content information” refers to expression content information generated by a generative artificial intelligence model in response to an emotion-dependent prompt sentence, such that the content is tailored to a detected user emotion.

The term “recommendation target information” refers to information identifying items, services, or content that are proposed for presentation to a user as recommendations, optionally selected based on user emotion information, distribution history, or model outputs.

The term “real time” refers to processing that is performed with a latency sufficiently low that distribution policy information and content can be updated and applied while a user's current interaction or session is ongoing.

The term “display history information” refers to information representing past instances in which content was displayed to users, including timestamps, identifiers of content variants, and contextual parameters.

The term “response history information” refers to information representing user reactions to displayed content, including but not limited to clicks, dwell times, scrolling, purchases, or other interaction signals.

The term “training history” refers to an accumulated dataset that consists of related information, display history information, response history information, and user emotion information, and that is used for training or updating estimation models and prompt sentence generation logic.

The term “prompt sentence generation logic” refers to a set of rules, models, or algorithms used by the processor to construct prompt sentences for input to a generative artificial intelligence model, based on related information, model outputs, user inputs, and user emotion information.

The term “optimization accuracy” refers to a degree to which computed distribution policy information and expression content information achieve desired performance indicators, measured for example by proximity to optimal values under given constraints.

The term “closed-loop optimization pipeline” refers to a processing architecture in which outputs of distribution processes, including performance metrics and user emotion responses, are fed back into data acquisition, model training, and prompt generation, so that future distribution policy information and content are iteratively improved.

In one embodiment, a server implements the claimed system as a network-connected computing apparatus including at least one processor, a main memory, a non-volatile storage device, and a network interface. The server executes an operating system, a database management system, and an application stack that includes a data processing module, a model training and inference module, a prompt generation module, and an external platform communication module. The server communicates with at least one terminal via a communication network. The terminal includes a processor, a display, a camera as a visual acquisition unit, a microphone as an audio acquisition unit, local memory, and a communication interface. A user operates the terminal to configure campaigns and to view content.

The server uses a relational database management system, such as a generic relational database engine, to store distribution-related information, item-related information, result-related information, and training history. The server uses a data analysis library, such as a generic tabular data processing library, to load tables (for example, a “delivery_log” table, an “item_master” table, and a “result_log” table) into in-memory tabular structures. Each record in the delivery_log table stores fields such as campaign_id, item_id, timestamp, region_code, device_type, bid_value, delivered_flag, and platform_identifier. Each record in the result_log table stores fields such as delivery_log_id, click_flag, conversion_flag, revenue_amount, and dwell_time. Each record in the item_master table stores fields such as item_id, category_code, price, and textual_description.

The server integrates these records into a unified preprocessed data set by joining the tables on item_id and delivery_log_id and by aligning timestamps into discrete time periods (for example, hour-of-day and day-of-week). The server executes data processing routines to complete missing values (for example, by imputing missing bid_value entries using median values per campaign and time period), to remove abnormal values (for example, by discarding records whose revenue_amount is greater than a threshold multiple of the interquartile range), and to normalize numerical features (for example, scaling bid_value and price to zero-mean, unit-variance). The server converts categorical fields, such as region_code, device_type, and category_code, into numerical vectors using techniques such as one-hot encoding or learned embeddings. This structured preprocessed data set is stored as a two-dimensional matrix X (features) and corresponding target vectors y for various performance indicators, such as conversion_flag or revenue_amount.

The server uses a model training and inference module implemented with a numerical computation framework, such as a generic tensor computation library or a generic machine learning library, to construct a trained estimation model. In one implementation, the server constructs a gradient boosted decision tree model that predicts conversion probability given feature vectors derived from X. In another implementation, the server constructs a neural network model having an input layer matching the dimensionality of the feature vectors, one or more fully connected hidden layers, and an output layer producing either a conversion probability or expected revenue. The server defines an objective function, such as binary cross-entropy for conversion prediction or mean squared error for revenue prediction, and uses stochastic gradient descent or a variant (for example, Adam optimization) to update model weights. The server partitions the preprocessed data into training and validation subsets and iteratively updates weights until validation performance stabilizes or improves less than a threshold, thereby preventing overfitting. The server stores the resulting trained estimation model parameters in the storage device for later inference.

The server uses the trained estimation model to compute performance indicators for hypothetical combinations of distribution control parameters. For example, the server forms candidate vectors representing specific combinations of bid_value, distribution time period (encoded as hour-of-day and day-of-week), and distribution area (encoded as region_code), while keeping other features, such as item category and device_type, fixed or sampled from historical distributions. The server applies the trained estimation model to each candidate vector to obtain predicted conversion probabilities or expected revenue. The server then executes an optimization routine that selects a set of distribution control parameters satisfying the user's resource allocation information. In one implementation, the server solves a constrained optimization problem where the objective is to maximize predicted total conversions under a total budget constraint. The server can implement this by a greedy algorithm that allocates budget to time periods and regions with highest conversion per unit cost, or by a more advanced method such as linear programming or evolutionary search. The server generates optimized distribution policy information, which includes, for each time period and region, a recommended bid_value and an expected volume of impressions consistent with the budget.

The server also constructs and uses a generative AI model as a separate component from the trained estimation model. The generative AI model is, in one embodiment, a transformer-based neural network trained to predict sequences of tokens in a natural language. The server accesses this generative AI model via an application programming interface provided by a model hosting service or by an on-premise inference engine. The model receives an input sequence, referred to as a prompt sentence, and produces an output sequence representing distribution strategies or expression content.

The server executes a prompt generation module to construct prompt sentences in natural language. The module uses the optimized distribution policy information, item-related information, and resource allocation information as inputs. The server forms textual descriptions, such as “Product category: lightweight portable electronic device. Target audience: women in their twenties. Best performing time slots: weekday evenings in urban areas.” The server then concatenates these descriptions with explicit instructions to the content generation algorithm. For example, the server generates a prompt sentence such as: “The advertiser wants to promote Product A for 2 weeks with a budget of 1,000,000 yen. Product A is a lightweight, easy-to-carry device targeted at women in their 20s. Historical data show that weekday evenings in urban regions convert best. Based on this information, please propose a detailed advertising strategy and generate three high-converting ad copies suitable for smartphone display ads.”

In another embodiment, the server generates emotion-dependent prompt sentences that explicitly incorporate user emotion information. For example, when user state information indicates that the user is joyful, the server generates a prompt such as:
“The user is currently smiling and classified as ‘joyful’ by our emotion engine. Past campaigns show that joyful users respond well to travel and entertainment offers. Please generate three ad copies for weekend city-break travel packages that further amplify joy, each suitable for a smartphone banner.”

The server sends these prompt sentences to the generative AI model and receives generated content. The generative AI model outputs sequences that contain, for example, multiple headline candidates, body text variants, and calls-to-action. The server parses the output using rule-based delimiters or patterns embedded in the prompt (for example, “Headline 1: . . . ; Description 1: . . . ”) and stores each candidate as a record in a content_variant table linked to the corresponding campaign.

The terminal presents these generated content variants and the associated distribution policy information to the user. The terminal executes a user interface module implemented, for example, with a browser-based rendering engine or a native application framework. The terminal retrieves JSON-formatted summary data from the server and converts it into visual elements such as lists, cards, and charts. The user can select or edit specific content variants. The terminal transmits the user's selections and modifications back to the server, where the processor updates the stored distribution policy information and expression content information. This interactive mechanism allows human oversight while the bulk of the content synthesis and policy derivation is performed by machine, and the server manages data structures and updates in a consistent, machine-readable way.

The server further uses an external platform communication module to configure and control external distribution platform apparatuses. The server transforms the optimized distribution policy information and selected content variants into platform-specific configuration data. For example, the server maps internal time period and region representations to external platform time zone and geo-targeting codes. The server then uses application programming interfaces, such as generic REST interfaces provided by the platforms, to create or update campaigns, ad groups, and creatives. The server stores external identifiers returned by the platforms and associates them with internal campaign and content identifiers. During live operation, the server retrieves performance metrics from the external platforms and merges them back into the result_log table. By executing these operations automatically, the server reduces manual configuration errors and improves the timeliness and consistency of campaign updates.

The terminal also acts as a sensor platform to provide user state information. The terminal activates its camera and microphone in accordance with user consent, captures image frames and audio segments while content is displayed, and runs an on-device emotion estimation algorithm. The terminal may use a convolutional neural network for facial expression recognition, with an architecture consisting of multiple convolutional layers, pooling layers, and fully connected layers that output probabilities for emotions such as joy, sadness, surprise, and neutrality. For audio, the terminal may extract features such as Mel-frequency cepstral coefficients and use a recurrent or transformer-based network to infer emotional tone. The terminal compresses these inference results into user emotion information, which includes an emotion label and a confidence score, and transmits this information to the server along with content identifiers and timestamps.

The server receives the user emotion information and records a correspondence between the emotion and the specific content variant and distribution policy under which the emotion was observed. The server stores this correspondence in a history structure that joins the delivery_log, result_log, and an emotion_log table. The emotion_log table contains fields such as timestamp, user_identifier (or session identifier), content_variant_id, emotion_label, and confidence_score. This enriched training history enables the server to analyze which distribution control parameters and content variants tend to elicit favorable emotions, such as joy or calmness, that correlate with higher conversions.

The server periodically re-trains the estimation model using the extended training history. In one embodiment, the server adds emotion-related features to the feature vectors, such as probabilities of specific emotion categories or aggregated emotion statistics per segment. The server then updates model parameters using the same training procedure described above. The server also uses the training history to update the prompt sentence generation logic. For example, the server may derive rules or learned models that select which attributes and performance summaries to emphasize in prompt sentences. The server can learn that certain combinations of item categories and emotion labels require specific wording or instruction types to elicit high-quality outputs from the generative AI model. This feedback loop improves the relevance and diversity of generated content while reducing the need to manually craft prompts.

The described architecture improves computer technology in several ways. First, by integrating predictive estimation models with generative AI models through explicit prompt sentence generation, the server creates an end-to-end pipeline in which structured numerical optimization results are converted into natural-language instructions for content synthesis. This conversion is executed by algorithmic modules that dynamically vary prompt content based on current model outputs and user state, which differs from static, manually authored prompts. As a result, the computing system reduces the number of iterations required to obtain effective content, thereby improving overall processing throughput and reducing network round-trips to the generative AI model.

Second, by using specific data structures (joined tables, feature matrices, and emotion-augmented logs) and machine learning models (gradient boosted decision trees or multi-layer neural networks with defined loss functions and optimization algorithms), the server can more accurately predict and optimize performance indicators than rule-based systems. The trained estimation model can process high-dimensional feature vectors at inference time with low latency, so the server can update bids and schedules frequently, improving responsiveness to changing conditions without manual intervention.

Third, the system's use of user emotion information as a first-class feature, linked at the record level to distribution policies and content variants, allows the processor to implement non-conventional control loops. Instead of merely reacting to clicks or conversions, the processor anticipates performance by selecting content and parameters that historically lead to favorable emotional responses. This yields technical effects such as reduced variance in conversion rates and more stable performance across different user cohorts, which in turn reduces the number of model updates and data transfers required to maintain target performance levels.

Fourth, the architecture reduces storage and communication overhead by maintaining a structured, normalized training history rather than ad hoc event logs. By encoding categorical information numerically and by aggregating performance metrics at appropriate granularities (for example, per hour and region), the server diminishes the volume of data that must be re-processed for each model retraining run. This directly improves computational efficiency and decreases energy consumption for large-scale deployments.

In alternative embodiments, the server can employ different estimation model architectures, such as recurrent neural networks for modeling temporal dependencies in delivery logs or graph-based models for capturing relationships among items and user segments. The prompt generation logic can also vary, for example by using template-based prompts with slots filled by data-driven selections, or by using a small neural network that maps numerical summaries to textual instructions. The generative AI model can be hosted locally or externally, and may generate not only textual content but also symbolic strategy representations, which the server can post-process into executable policy configurations.

In all embodiments, the server, terminal, and user cooperate in a way that is not a mere automation of manual human decision-making. The server performs large-scale numerical optimization, structured prompt sentence generation, and model-driven content synthesis in closed loops that require the capabilities of digital processors and cannot feasibly be replicated manually in real time. The specific integration of estimation models, generative AI models, and emotion-aware feedback within a unified data flow yields improvements in accuracy, speed, and resource utilization of the computer system executing distribution processes.

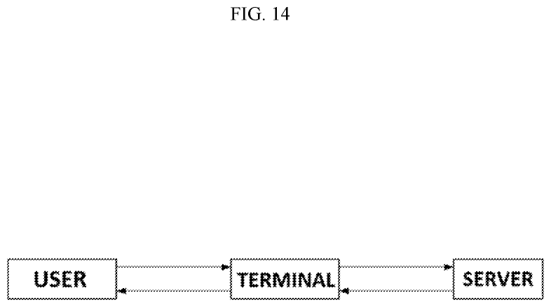

The following describes the processing flow using FIG. 14.
Step 1:

The user operates the terminal to open a campaign configuration screen.

The terminal displays input fields for target identification information, distribution period, and resource allocation information.

Input: Manual entries by the user, such as “Product A”, “2 weeks”, “Budget 1,000,000 yen”, and optional target audience.

The terminal converts these inputs into a structured data object including fields such as item_id, start_date, end_date, total_budget, and target_audience.

Output: A structured configuration payload.

The terminal transmits the configuration payload to the server via a network connection using a secure protocol.
Step 2:

The server receives the configuration payload from the terminal.

Input: The configuration payload containing item_id, distribution period, and resource allocation information.

The server validates the payload by checking, for example, that the item_id exists in an item_master table, that the distribution period is within allowed bounds, and that the total_budget is a positive numeric value.

The server writes the validated configuration into a campaign table in a storage device, assigning a new campaign_id.

Output: A stored campaign record and a confirmation message including the campaign_id.

The server transmits the confirmation message to the terminal for display to the user.
Step 3:

The server acquires related information from the storage device.

Input: The campaign_id and item_id associated with the new campaign.

The server executes database queries to retrieve distribution-related information from a delivery_log table, item-related information from an item_master table, and result-related information from a result_log table.

The server joins these tables on shared keys such as item_id and delivery_log_id to generate an integrated raw data set.

Output: An integrated raw data set composed of records containing fields such as item attributes, distribution parameters, and outcome metrics.
Step 4:

The server preprocesses the integrated raw data set to create a preprocessed data set.

Input: The integrated raw data set.

The server performs completion of missing values by applying statistical imputation, such as replacing missing bid_value entries with median bid_value per campaign and time period.

The server performs removal of abnormal values by discarding records whose numeric fields, such as revenue_amount, exceed a threshold defined using distribution statistics.

The server normalizes numerical features such as bid_value and price using scaling rules to achieve zero mean and unit variance.

The server converts categorical fields, such as region_code and device_type, into numerical vectors using one-hot encoding or embedding mappings.

Output: A preprocessed data set represented as a feature matrix X and associated target vectors y for selected performance indicators.
Step 5:

The server constructs a trained estimation model using the preprocessed data set.

Input: The feature matrix X and target vectors y.

The server divides the data into training and validation subsets according to a predetermined ratio.

The server initializes model parameters for a prediction algorithm, such as a neural network or a gradient boosted tree model.

The server iteratively updates the model parameters by minimizing a loss function, such as binary cross-entropy for conversion_flag, using an optimization method such as stochastic gradient descent.

The server evaluates the model on the validation subset to monitor performance and stops training when validation loss converges or improves less than a threshold.

Output: A trained estimation model with fixed parameters stored in the storage device.
Step 6:

The server derives optimized distribution control parameters using the trained estimation model.

Input: The trained estimation model, the item-related information, and the resource allocation information, including total_budget.

The server generates candidate feature vectors by varying distribution control parameters such as bid_value, distribution time periods, and distribution areas while holding fixed other attributes such as item category.

The server applies the trained estimation model to each candidate vector to obtain predicted performance indicators, such as conversion probability or expected revenue per impression.

The server runs an optimization procedure that selects combinations of distribution control parameters that maximize a performance objective under the budget constraint; for example, the server computes predicted conversions per unit cost and allocates budget to the highest-ranking combinations until the total_budget is exhausted.

Output: Optimized distribution policy information specifying, for each time period and area, recommended bid values and allocated budget amounts.
Step 7:

The server generates a prompt sentence for a generative AI model based on the optimized distribution policy.

Input: The optimized distribution policy information, the item-related information, and the resource allocation information.

The server converts numerical and categorical values into textual descriptions, such as “weekday evenings”, “urban regions”, “lightweight portable device”, and “budget 1,000,000 yen”.

The server assembles these descriptions with explicit instructions to generate strategy and content, forming a natural-language prompt sentence.

Example prompt sentence:
“The advertiser wants to promote Product A for 2 weeks with a budget of 1,000,000 yen. Product A is a lightweight, easy-to-carry device targeted at women in their 20s. Historical data show that weekday evenings in urban regions convert best. Based on this information, please propose a detailed advertising strategy and generate three high-converting ad copies suitable for smartphone display ads.”

Output: A constructed prompt sentence in natural language.
Step 8:

The server transmits the prompt sentence to a generative AI model and receives generated content.

Input: The prompt sentence generated in Step 7.

The server sends the prompt sentence to the generative AI model via an application programming interface and specifies generation parameters such as maximum token length and temperature.

The generative AI model produces a text output containing proposed strategy refinements and multiple candidate ad texts with delineated segments for headlines and descriptions.

The server parses the returned text by recognizing markers such as “Headline 1:” and “Description 1:” and segments the text into structured content records.

Output: A set of structured expression content information records and, optionally, refined distribution policy descriptions associated with the campaign.
Step 9:

The server stores and associates the generated content with the optimized distribution policy.

Input: The structured expression content information and the optimized distribution policy information.

The server inserts new records into a content_variant table, including fields such as campaign_id, variant_id, headline_text, description_text, and associated policy attributes.

The server links each content variant to the corresponding distribution control parameters, such as time periods and regions, by storing relations in a mapping table.

Output: Persisted content variants and mappings ready for review and later deployment.
Step 10:

The server sends the optimized policy and generated content to the terminal for user review.

Input: The campaign_id, optimized distribution policy information, and content_variant records.

The server creates a summary data object that includes human-readable descriptions of the policy and a list of content variants.

The server transmits this summary data to the terminal over the network.

Output: A response payload containing policy and content data for user presentation.
Step 11:

The terminal displays the policy and content to the user and captures feedback.

Input: The summary data received from the server.

The terminal renders graphical components, such as a table of time periods and bid values, charts of predicted performance, and cards for each ad variant showing headlines and descriptions.

The user reviews the information and may edit text fields or adjust parameters, such as disabling certain time periods or changing a headline.

The terminal records the user's edits and selections and packages them into an updated configuration payload.

Output: A user feedback payload containing selected and modified policy and content data.

The terminal transmits the user feedback payload back to the server.
Step 12:

The server updates the distribution policy and content based on user feedback.

Input: The user feedback payload containing modifications and approvals.

The server applies updates to the campaign record, replacing or overriding fields that the user edited, such as selected content variants or excluded time periods.

The server updates related tables in the storage device so that the finalized policy and content are consistently stored.

Output: A finalized set of distribution policy information and expression content information, ready for deployment to external platforms.
Step 13:

The server configures external distribution platforms using the finalized policy and content.

Input: The finalized distribution policy information, the expression content information, and mapping rules between internal and external platform parameters.

The server constructs platform-specific configuration requests that map internal fields, such as bid_value and region_code, to corresponding fields defined by each external platform.

The server transmits these configuration requests via external platform APIs to create or update campaigns, ad groups, and creatives.

The server receives external identifiers from the platforms and stores them in association with the internal campaign_id and variant_id.

Output: Active configurations on external distribution platforms aligned with the internal policy and content.
Step 14:

The terminal acquires user state information while content is displayed and transmits emotion data to the server.

Input: The current content displayed on the terminal and the active camera and microphone signals.

The terminal captures image frames of the user's face and audio segments of the user's voice during content viewing.

The terminal runs on-device emotion estimation algorithms that extract facial features and acoustic features and classify the current emotion as categories such as joy, neutrality, or surprise, with associated confidence scores.

The terminal creates a user state record containing the emotion label, confidence score, timestamp, and identifiers of the displayed content and campaign.

Output: A user emotion information payload.

The terminal transmits the user emotion information payload to the server.
Step 15:

The server records the emotion information and links it to policy and content.

Input: The user emotion information payload and existing delivery_log and content_variant data.

The server creates an entry in an emotion_log table containing the emotion label, confidence score, timestamp, and references to delivery_log_id and content_variant_id.

The server thereby establishes a correspondence between specific distribution control parameters, concrete content variants, and user emotional responses.

Output: An updated training history that includes emotion-linked exposure records.
Step 16:

The server generates an emotion-dependent prompt sentence and updates content or recommendations.

Input: The user emotion information, the established correspondence data, and historical performance statistics for similar emotions.

The server analyzes which item categories and content patterns historically produce favorable outcomes under the detected emotion.

The server creates an emotion-dependent prompt sentence that explicitly describes the current emotion and instructs the generative AI model to generate content tailored to that emotion.

Example prompt sentence: “The user is currently smiling and classified as ‘joyful’ by our emotion engine. Past data show that joyful users respond well to entertainment and travel products. Please generate three banner ad messages that enhance the user's joyful mood and promote weekend city-break packages.”

The server sends this emotion-dependent prompt sentence to the generative AI model and receives new emotion-specific content variants.

Output: Additional emotion-dependent expression content information and, if applicable, refined recommendation target information.
Step 17:

The server updates live distribution policy based on emotion-dependent content.

Input: The emotion-dependent content variants and the current distribution policy information.

The server re-ranks available content variants using rules or learned scores that prioritize variants suited to the detected emotion.

The server adjusts distribution policy mappings so that, for certain user segments or sessions with particular emotion labels, the server selects the emotion-dependent variants for delivery.

The server transmits updated content selection instructions to the terminal or to external platforms, depending on the delivery configuration.

Output: A dynamically updated distribution policy that accounts for real-time user emotion.
Step 18:

The server collects live performance and continuously refines models and prompt generation logic.

Input: Ongoing delivery_log data, result_log data, and emotion_log data from external platforms and terminals.

The server periodically aggregates these logs to update performance statistics and to extend the training history.

The server re-trains the estimation model using the extended training history, incorporating new features derived from emotion and recent performance.

The server also revises the prompt sentence generation logic by analyzing which prompt patterns produce high-performing content, adjusting templates or weights used to assemble prompt sentences.

Output: Updated estimation models and updated prompt generation rules that improve prediction accuracy and content quality over time.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

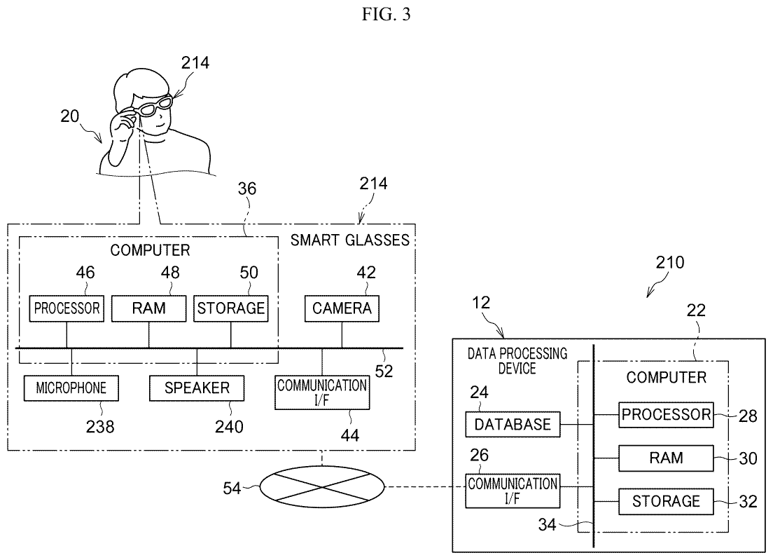

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

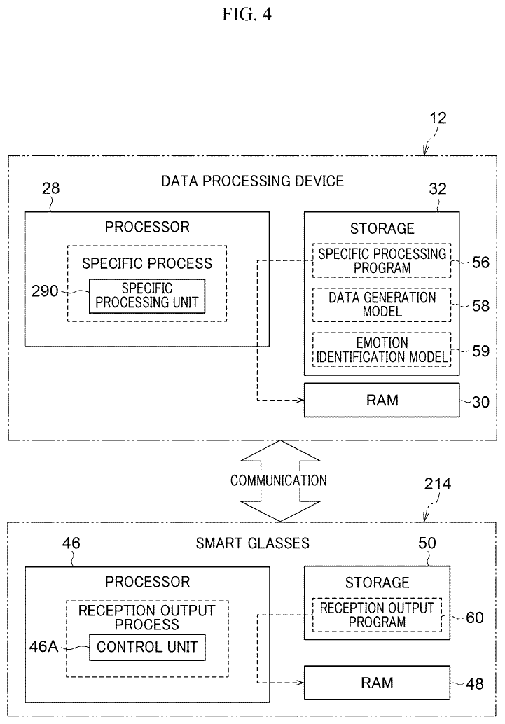

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

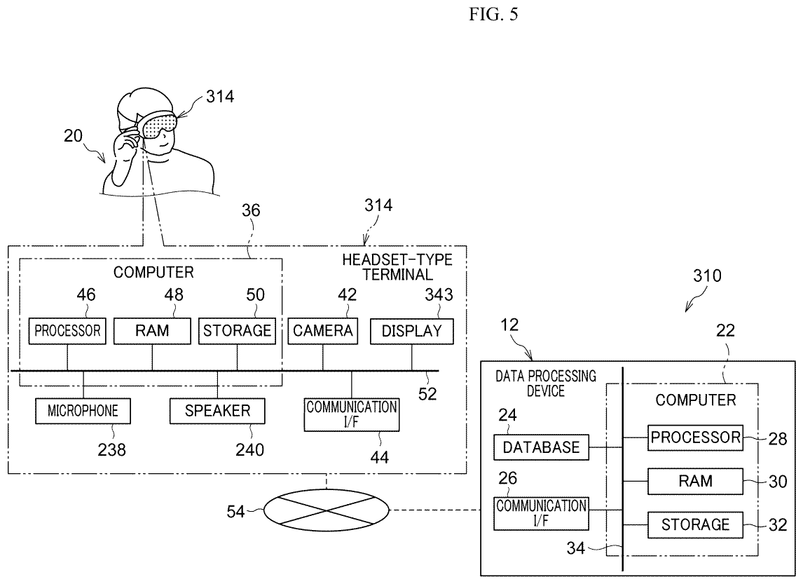

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

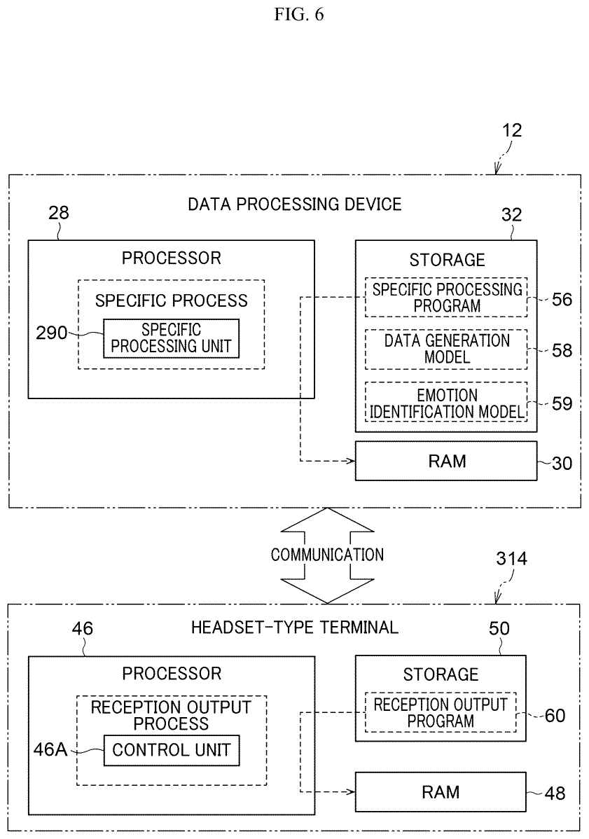

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

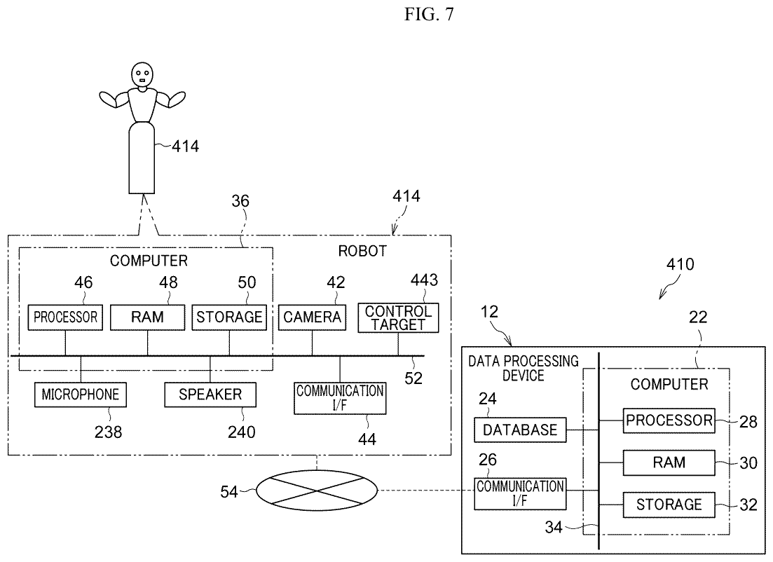

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

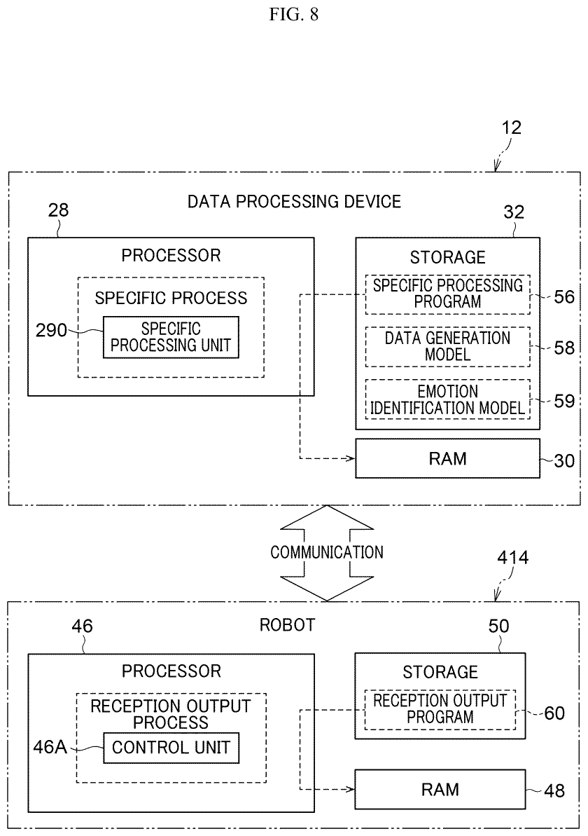

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

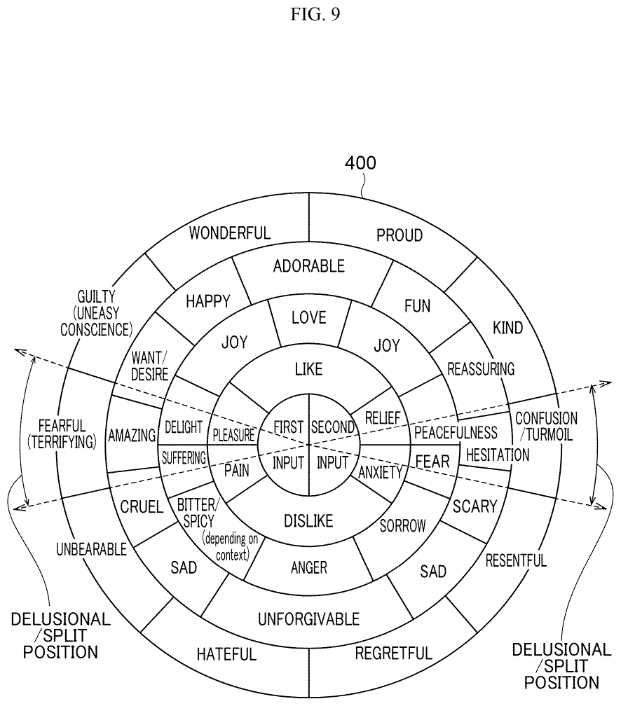

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

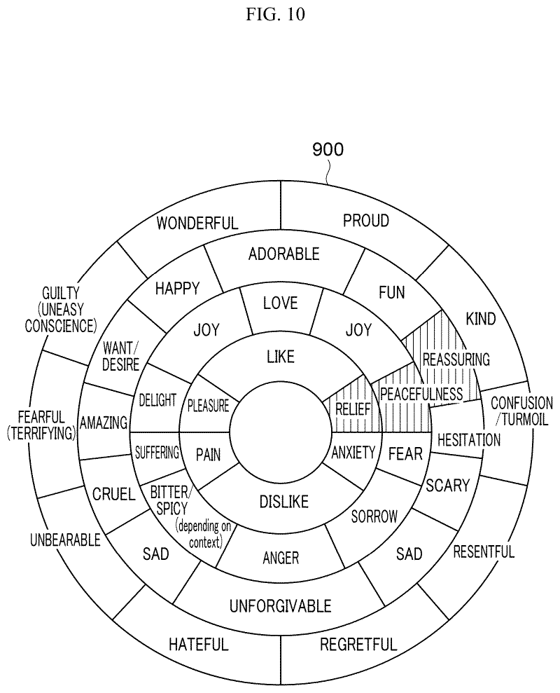

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
retrieve, from an information collection stored in the storage device, delivery history information related to information distribution, attribute information related to a distribution target item, performance information related to a transaction result, and information related thereto, and
provide, by using a display device and an input device, a user interface screen for allowing a user to input condition information including identification information of the distribution target item, a distribution period, and a distribution budget, and acquire the condition information input by the user, and
perform statistical processing and numerical calculation on the retrieved delivery history information, attribute information, and performance information to generate evaluation indices including at least a click rate, a conversion rate, an acquisition cost, and a return on investment for each of a time slot, a terminal type, and a recipient attribute, and extract, based on the evaluation indices, distribution conditions and allocation policies having high effectiveness of information distribution, and
generate, based on the extracted distribution conditions and allocation policies and the condition information input by the user, a prompt sentence including an instruction statement for instructing a generative artificial intelligence model to generate a distribution plan, and embed summary information of the delivery history information and the evaluation indices into the prompt sentence and transmit the prompt sentence as input to the generative artificial intelligence model, and
acquire, from the generative artificial intelligence model, structured distribution plan information including at least a bidding method, a budget allocation, a distribution time slot, a recipient attribute, and a predicted number of conversions, and perform numerical adjustment processing on the distribution plan information so that the distribution plan information satisfies the distribution budget condition of the user, and
convert the distribution plan information after the numerical adjustment into a format displayable on the user interface screen and output the distribution plan information to the display device, and receive an approval instruction from the user, and
in response to the approval instruction from the user, register, through a communication interface of an external distribution infrastructure, a distribution setting based on the distribution plan information.

### (Supplementary 2)

The system according to supplementary 1,
wherein the processor is configured to, when the condition information including the identification information of the distribution target item, the distribution period, and the distribution budget input by the user is accepted, preferentially extract, from among the evaluation indices obtained by the statistical processing and the numerical calculation, a time slot and a recipient attribute in which the conversion rate or the return on investment is equal to or greater than a predetermined threshold in a predetermined period, and describe an extraction result as an explicit constraint condition in the prompt sentence so as to instruct the generative artificial intelligence model to optimize a distribution schedule and a budget allocation.

### (Supplementary 3)

The system according to supplementary 1,
wherein the processor is configured to generate a training prompt sentence and teacher information for training or fine-tuning the generative artificial intelligence model by using the evaluation indices generated based on the delivery history information, the attribute information, and the performance information, and input the training prompt sentence to the generative artificial intelligence model to obtain a generative artificial intelligence model having improved accuracy in deriving a distribution strategy based on past distribution results, and use the generative artificial intelligence model having the improved accuracy to acquire the distribution plan information.

### Application Example 1

### (Supplementary 1)

A system comprising a processor,
wherein the processor is configured to
acquire, from an information storage device storing a plurality of records including historical information, distribution history information related to advertising distribution, attribute history information related to goods, and transaction history information related to sales performance, and to load the acquired historical information as tabular data and perform preprocessing including missing-value completion, value conversion, attribute integration, and indicator calculation so as to generate a group of features suitable for learning processing and inference processing,
to construct a prediction model by using a machine learning algorithm based on the group of features and a performance indicator included in the historical information, to input a plurality of candidate distribution conditions including bid levels, target attributes, distribution time periods, and budget allocation patterns into the prediction model, to estimate the performance indicator for each of the candidate distribution conditions, and to identify optimal distribution conditions in which the performance indicator is maximized while satisfying a given budget condition and a constraint condition,
to provide, via a display control unit operating on an information display device, an operation screen that allows a user to input target identification information of an advertisement display target, a distribution period, an allocation budget, and distribution conditions, to view the optimal distribution conditions, and to specify modification content with respect to the optimal distribution conditions,
to perform communication with an external distribution management service based on the optimal distribution conditions and the modification content, and to automatically register or update distribution setting information in the external distribution management service as the distribution setting information including a distribution target, a bidding strategy, a distribution schedule, and a budget allocation,
to generate summary information based on the historical information and the optimal distribution conditions, the summary information including at least a campaign objective, a period, a budget, a target attribute, a distribution result indicator, and a constraint condition, to generate a prompt sentence including the summary information, to input the prompt sentence into a generative information processing model, and to analyze proposal content in natural language obtained from the generative information processing model so as to extract improvement plans including at least bid adjustment, target change, time period allocation change, and budget reallocation, and
to convert, among the improvement plans, plans selected by the user into an update request to the external distribution management service, to change the distribution setting information based on the update request, and to accumulate a distribution result indicator after the change, as historical information, in the information storage device.

### (Supplementary 2)

The system according to supplementary 1,
wherein the processor is configured to
extract, from the historical information, a partial set related to the target identification information based on the target identification information, the distribution period, and the allocation budget input by the user, to apply the prediction model to the partial set so as to estimate the performance indicator on a distribution-date basis or on a time-period basis, to determine a distribution schedule and a daily budget allocation in which the performance indicator is maximized, to generate a prompt sentence including a determination result, and to input the prompt sentence into the generative information processing model so as to cause the generative information processing model to perform validity evaluation of and generation of a modification plan for the distribution schedule and the daily budget allocation.

### (Supplementary 3)

The system according to supplementary 1,
wherein the processor is configured to
acquire, at predetermined intervals, a distribution result indicator from the external distribution management service, to add the distribution result indicator to the historical information, to perform relearning of the prediction model based on the historical information after the addition, to calculate new optimal distribution conditions based on the relearned prediction model, to generate a prompt sentence including summary information relating to the new optimal distribution conditions, and to input the prompt sentence into the generative information processing model so as to obtain continuous improvement proposals for an advertising distribution strategy.

### Example 2

### (Supplementary 1)

A system comprising a processor,
wherein the processor is configured to
acquire, from a storage device, related data including advertising distribution information, product information, sales history information, and advertising effectiveness information, calculate click-through rates, conversion rates, and revenue indicators for the related data, and perform aggregation and feature generation based on time period, day of week, device type, and user attribute,
provide, to a terminal, a user interface screen that allows a user to input product identification information of an advertising target, an advertising execution period, and an advertising budget, receive input information from the terminal, store the input information in the storage device, and manage the input information as constraint conditions for optimization processing,
generate or update, by using a machine learning algorithm and on the basis of the related data and the input information, a performance prediction model for each advertising distribution segment, and calculate, by using the performance prediction model, a predicted number of conversions or predicted revenue for a plurality of advertising distribution candidate plans, search, on the basis of an output of the performance prediction model and on the basis of the advertising budget and the advertising execution period as constraints, for an advertising distribution strategy in which budget allocation and bid parameters for each combination of time period, day of week, device type, and user attribute are treated as variables, and identify an optimized advertising distribution strategy that maximizes a predetermined objective function,
generate structured data representing the optimized advertising distribution strategy and key indicators serving as a basis of the optimized advertising distribution strategy, generate a prompt sentence for causing a generative AI model to generate an explanatory sentence and proposal content for the advertising distribution strategy on the basis of optimization results including the structured data, and input the prompt sentence and the structured data to the generative AI model, and
transmit, to the terminal, a natural language explanatory sentence of the advertising distribution strategy output from the generative AI model and the optimized advertising distribution strategy, and cause the terminal to convert the explanatory sentence and the optimized advertising distribution strategy into a format that is visually displayable on the terminal.

### (Supplementary 2)

The system according to supplementary 1,
wherein the processor is configured to
automatically generate the prompt sentence by combining the structured data regarding the optimized advertising distribution strategy with statistical information extracted from the related data, the prompt sentence including recommended budget allocation, bid adjustment rates, and expected numbers of conversions for each combination of time period, day of week, device type, and user attribute, and input the prompt sentence, together with the structured data and the statistical information, to the generative AI model.

### (Supplementary 3)

The system according to supplementary 1,
wherein the processor is configured to
recalculate the optimized advertising distribution strategy on the basis of, in addition to the product identification information of the advertising target, the advertising execution period, and the advertising budget input by the user from the terminal, additional constraint conditions or adjustment requests received from the terminal, generate new structured data corresponding to the recalculated advertising distribution strategy, automatically generate a new prompt sentence for the generative AI model by using the new structured data, and cause the generative AI model to regenerate an explanatory sentence of the recalculated advertising distribution strategy.

### Application Example 2

### (Supplementary 1)

A system comprising a processor,
wherein the processor is configured to
acquire, from a storage device, a set of related information including distribution-related information, item-related information, and result-related information, provide an input/output interface that allows a user to input target identification information for display, a distribution period, and resource allocation information, integrate the acquired related information and perform preprocessing including completion of missing values, removal of abnormal values, normalization, and numerical conversion of categorical information, thereby generating a preprocessed data set,
construct, on the basis of the preprocessed data set, a trained estimation model by using a prediction algorithm to estimate performance indicators, and, by using the trained estimation model, search distribution control parameters including bid values, distribution time zones, and distribution areas under a constraint of the resource allocation information so as to derive optimized distribution policy information,
generate, on the basis of the target identification information, the distribution period, the resource allocation information, and the optimized distribution policy information, a prompt sentence in a natural language that instructs a content generation algorithm to generate an advertising distribution policy and advertising expression content,
input the prompt sentence to a generative artificial intelligence model and store, in association with the optimized distribution policy information, advertising distribution policy information and advertising expression content information obtained from the generative artificial intelligence model,
transmit, to a display apparatus, the advertising distribution policy information and the advertising expression content information as display data, receive confirmation and correction input from the user, and update the advertising distribution policy information and the advertising expression content information on the basis of the correction input, transmit, to an external distribution platform apparatus, distribution setting information corresponding to the updated advertising distribution policy information and the advertising expression content information, and cause the external distribution platform apparatus to start an advertising distribution process,
receive user state information transmitted from a terminal apparatus including a visual acquisition unit and an audio acquisition unit, specify user emotion information by using an emotion estimation algorithm, and record a correspondence between the user emotion information and the advertising distribution policy information and the advertising expression content information, and
generate, on the basis of the user emotion information and the correspondence, an emotion-dependent prompt sentence to be input to the generative artificial intelligence model, cause the generative artificial intelligence model to additionally generate emotion-dependent advertising expression content information or recommendation target information by using the emotion-dependent prompt sentence, and update the advertising distribution policy information in real time.

### (Supplementary 2)

The system according to supplementary 1,
wherein the processor is configured to control a terminal apparatus to accept, in response to an operation of the user, the target identification information, the distribution period, and the resource allocation information via an input screen, to transmit the accepted information as structured data via a communication path, and to cause the terminal apparatus to display, in a list format, a plurality of types of advertising expression content information and estimated performance information by distribution time zone generated by the generative artificial intelligence model, to acquire a selection operation or an editing operation by the user, and to receive the selection operation or the editing operation from the terminal apparatus.

### (Supplementary 3)

The system according to supplementary 1,
wherein the processor is configured to store, as training history, display history information, response history information, and the user emotion information acquired from the external distribution platform apparatus and the terminal apparatus by successively adding the display history information, the response history information, and the user emotion information to the related information, and, on the basis of the training history, periodically update the trained estimation model and a prompt sentence generation logic for input to the generative artificial intelligence model so as to continuously improve optimization accuracy of the advertising distribution policy information and the advertising expression content information.

What is claimed is:

1. A system comprising:
circuitry configured to communicate, via a communication interface coupled to a packet-switched network, with a terminal device, the circuitry being further configured to:
retrieve, from a storage device, historical information comprising distribution history data, attribute data of a target item, and performance data;
receive, from the terminal device via the communication interface, condition data comprising identification information of the target item, a distribution period, and a budget value;
perform statistical processing on the historical information to generate evaluation indices;
generate, based on the evaluation indices and the condition data, a prompt sentence for instructing a generative neural network model to generate structured plan data;
input the prompt sentence to the generative neural network model to acquire the structured plan data;
perform numerical adjustment processing on the structured plan data so that the structured plan data satisfies a constraint derived from the budget value; and
transmit the structured plan data after the numerical adjustment to the terminal device via the communication interface for presentation on the terminal device.

2. The system according to claim 1, wherein the evaluation indices comprise at least one of a click rate, a conversion rate, an acquisition cost value, and a return-on-investment value, each computed for a respective combination of a time slot, a terminal type, and a recipient attribute.

3. The system according to claim 2, wherein the circuitry is configured to extract, from among the evaluation indices, combinations in which the conversion rate or the return-on-investment value is equal to or greater than a predetermined threshold within a predetermined period, and to describe an extraction result as a constraint condition in the prompt sentence.

4. The system according to claim 3, wherein the circuitry is configured to instruct, via the constraint condition in the prompt sentence, the generative neural network model to optimize a distribution schedule and a budget allocation across the extracted combinations, and wherein the structured plan data comprises at least a bidding method, a budget allocation per time slot, a recipient attribute specification, and a predicted conversion count.

5. The system according to claim 1, wherein the circuitry is configured to embed, into the prompt sentence, summary information derived from the historical information and the evaluation indices together with an instruction statement directing the generative neural network model to generate the structured plan data.

6. The system according to claim 5, wherein the summary information comprises a tabular representation of the evaluation indices organized by time slot and recipient attribute, and wherein the instruction statement specifies at least one optimization objective selected from minimizing an acquisition cost, maximizing a conversion rate, and maximizing a return-on-investment value.

7. The system according to claim 6, wherein the circuitry is configured to generate the prompt sentence by filling a predetermined template with values derived from the condition data, the evaluation indices, and the summary information.

8. The system according to claim 7, wherein the predetermined template comprises a plurality of fields including a target item description field, a period field, a budget field, a historical performance summary field, and an optimization instruction field, and wherein the circuitry concatenates text values for each field to form the prompt sentence as a natural language instruction.

9. The system according to claim 1, wherein the circuitry is further configured to generate training data comprising training prompt sentences and corresponding teacher information based on the historical information and the evaluation indices.

10. The system according to claim 9, wherein the circuitry is configured to fine-tune the generative neural network model using the training data to improve accuracy in generating the structured plan data based on past distribution results.

11. The system according to claim 10, wherein the fine-tuning comprises computing a loss function between a predicted output of the generative neural network model and the teacher information, and updating parameters of the generative neural network model by backpropagation based on the loss function.

12. The system according to claim 1, wherein the circuitry is further configured to perform preprocessing on the historical information, the preprocessing comprising at least one of missing-value completion, value conversion, attribute integration, and indicator calculation to generate a group of features.

13. The system according to claim 12, wherein the circuitry is configured to construct a prediction model by executing a machine learning algorithm on the group of features, and to input at least a portion of the condition data to the prediction model to generate predicted performance values.

14. The system according to claim 13, wherein the circuitry is configured to incorporate the predicted performance values into the prompt sentence so that the generative neural network model generates the structured plan data in consideration of the predicted performance values.

15. The system according to claim 1, wherein the circuitry is further configured to convert the structured plan data into a format displayable on a user interface screen of the terminal device and to transmit the converted data to the terminal device, and to receive, from the terminal device via the communication interface, an approval instruction from a user.

16. The system according to claim 15, wherein the circuitry is configured to, in response to the approval instruction, register, via the communication interface and the packet-switched network with an external distribution processing apparatus, a distribution setting based on the structured plan data.

17. The system according to claim 4, wherein the distribution history data comprises advertising delivery records, wherein the target item comprises a product to be advertised, wherein the performance data comprises sales conversion records, and wherein the structured plan data comprises an advertising campaign delivery plan specifying daily budget allocations, target audience segments, and bidding strategies.

18. A system comprising:
circuitry configured to communicate, via a communication interface coupled to a packet-switched network, with a terminal device, the circuitry being further configured to:
retrieve, from a storage device, historical information comprising distribution history data, attribute data of a target item, and performance data;
receive, from the terminal device via the communication interface, condition data comprising identification information of the target item, a distribution period, and a budget value;
perform statistical processing on the historical information to generate evaluation indices comprising at least a click rate, a conversion rate, and a return-on-investment value for respective combinations of time slots and recipient attributes;
extract, from the evaluation indices, combinations satisfying a predetermined threshold condition;
generate, based on the extracted combinations and the condition data, a prompt sentence embedding summary information of the evaluation indices and instructing a generative neural network model to generate structured plan data;
input the prompt sentence to the generative neural network model to acquire the structured plan data;
perform numerical adjustment processing on the structured plan data so that the structured plan data satisfies a constraint derived from the budget value;
convert the structured plan data into a displayable format and transmit the displayable format to the terminal device via the communication interface;
receive, from the terminal device, an approval instruction; and
in response to the approval instruction, register a distribution setting based on the structured plan data with an external distribution processing apparatus via the packet-switched network.

19. The system according to claim 18, wherein the circuitry is further configured to generate training data based on the historical information and the evaluation indices, and to fine-tune the generative neural network model using the training data so that the generative neural network model generates the structured plan data with improved accuracy based on past distribution results.

20. A method performed by circuitry configured to communicate, via a communication interface coupled to a packet-switched network, with a terminal device, the method comprising:
retrieving, from a storage device, historical information comprising distribution history data, attribute data of a target item, and performance data;
receiving, from the terminal device via the communication interface, condition data comprising identification information of the target item, a distribution period, and a budget value;
performing statistical processing on the historical information to generate evaluation indices;
generating, based on the evaluation indices and the condition data, a prompt sentence for instructing a generative neural network model to generate structured plan data;
inputting the prompt sentence to the generative neural network model to acquire the structured plan data;
performing numerical adjustment processing on the structured plan data so that the structured plan data satisfies a constraint derived from the budget value; and
transmitting the structured plan data after the numerical adjustment to the terminal device via the communication interface for presentation on the terminal device.
